(19) United States
(12) Patent Application Publication
(10) Pub. No.: US 2018/0330357 A1
(43) Pub. Date: Nov. 15, 2018

(54) MOBILE TERMINAL AND METHOD OF CONTROLLING SAME

(71) Applicant: LG ELECTRONICS INC., Seoul (KR)

(72) Inventors: Hyukjoon JANG, Seoul (KR); Bumhyeon BAEK, Seoul (KR); Sunmi CHOI, Seoul (KR); Youngjun KIM, Seoul (KR); Harim JANG, Seoul (KR)

(73) Assignee: LG ELECTRONICS INC., Seoul (KR)

(21) Appl. No.: 15/774,256

(22) PCT Filed: Dec. 7, 2015
(86) PCT No.: PCT/KR2015/013307

§ 371 Date: May 7, 2018

(30) Foreign Application Priority Data
Nov. 30, 2015 (KR) 10-2015-0168442
Nov. 30, 2015 (KR) 10-2015-0168449

(51) Int. Cl. G06Q 20/32; G06Q 20/34

(52) U.S. Cl. CPC G06Q 20/3224; G06Q 20/34

(57) ABSTRACT

A mobile terminal according to an embodiment of the present invention comprises: first information identifying each of plural payment cards memory, second information on the use pattern of each of plural payment cards, third information corresponding to card benefits of each of plural payment cards, and fourth information on the current location of the mobile terminal. The control unit recognizes fifth information corresponding to the output priority of each of plural payment cards based on at least one of first information, second information, third information, and fourth information, and when it is recognized, based on the the fifth information, that the payment card having the highest output priority of the plural payment cards is a second payment card, the control unit controls the display unit to display a first message confirming whether to display a second indicator corresponding to the second payment card instead of the first indicator.

### TECHNICAL FIELD

The present invention relates to a mobile terminal and control method thereof.

### BACKGROUND ART

Terminals can be classified into mobile/portable terminals and stationary terminals. In particular, the mobile terminals can be further classified into handheld terminals and vehicle mounted terminals according to possibility of user's direct portability.

Recently, functions of a mobile terminal tend to be diversified. For instance, the diversified functions include a function of data and audio communication, a function of photographing and video-making through a camera, a function of audio recording, a function of music file play through a speaker system, a function of outputting an image or video to a display unit, and the like. A prescribed terminal is further equipped with an electronic game play function or performs a multimedia player function. Particularly, a recent mobile terminal is able to receive multicast signals for providing visual contents such as a broadcast, a video, a television program and the like.

As functions of the terminal are getting diversified, the terminal tends to be implemented as a multimedia player provided with complex functions such as photographing of photos or videos, playback of music or video files, game play, broadcast reception and the like for example.

To support and increase the terminal functions, it may be able to consider improving structural parts and/or software parts of the terminal.

Meanwhile, a mobile terminal can perform a payment function. Although the payment using the mobile terminal is convenient, methods of displaying an indicator corresponding to a payment card are very limitative in general. Therefore, the demand for a technique of displaying an indicator corresponding to a payment card in various ways is rising.

### DISCLOSURE OF THE INVENTION

### Technical Task

The present invention is intended to solve the above problem and other problems. One technical task of one embodiment of the present invention is to provide a mobile terminal and control method thereof, which can automatically change a payment displayed first by recognizing a current location of the mobile terminal, a payment card use pattern of a user, a current time and the like.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In one technical aspect of the present invention, provided herein is a mobile terminal, including a memory storing a first information for identifying each of a plurality of payment cards and a second information on a use pattern of each of a plurality of the payment cards, a wireless communication unit receiving a third information corresponding to card benefits of each of a plurality of the payment cards from an external server, a location information module obtaining a fourth information on a current location of the mobile terminal, a display unit displaying an indicator corresponding to each of a plurality of the payment cards based on the first information, and a controller controlling the display unit to first display a first indicator corresponding to a first payment card when the indicator corresponding to each of a plurality of the payment cards is displayed, wherein the controller recognizes a fifth information corresponding to an output priority of each of a plurality of the payment cards based on at least one of the first to fourth informations and wherein if recognizing that a payment card having a highest output priority among a plurality of the payment cards is a second payment card based on the fifth information, the controller controls the display unit to display a first message for checking whether to display a second indicator corresponding to the second payment card instead of the first indicator.

In another technical aspect of the present invention, provided herein is a method of controlling a mobile terminal, including saving a first information for identifying each of a plurality of payment cards and a second information on a use pattern of each of a plurality of the payment cards to a memory, receiving a third information corresponding to card benefits of each of a plurality of the payment cards from an external server, obtaining a fourth information on a current location of the mobile terminal, recognizing a fifth information corresponding to an output priority of each of a plurality of the payment cards based on at least one of the first to fourth information, displaying an indicator corresponding to each of a plurality of the payment cards based on the first information in a manner of first displaying a first indicator corresponding to a first payment card, and if recognizing that a payment card having a highest output priority among a plurality of the payment cards is a second payment card based on the fifth information, displaying a first message for checking whether to display a second indicator corresponding to the second payment card instead of the first indicator.

Technical solutions obtainable from the present invention may be non-limited by the above mentioned solutions. And, other unmentioned solutions can be clearly understood from the following description by those having ordinary skill in the technical field to which the present invention pertains.

### Advantageous Effects

Effects of a mobile terminal and control method thereof according to the present invention are described as follows.

According to at least one of embodiments of the present invention, a payment card displayed first is changed into a payment card most profitable to a user among payment cards of various types, thereby providing a user with convenience.

According to at least one of embodiments of the present invention, a credit card company can easily induce users to use cards of the credit card company.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1A is a block diagram to describe a mobile terminal related to the present disclosure.

FIGS. 1B and 1C are conceptual diagrams for one example of a mobile terminal related to the present invention, viewed from different directions.

FIG. 2 is a conceptual diagram to describe another example of a deformable mobile terminal 200 according to the present disclosure.

FIG. 3 is a perspective diagram for one example of a watch type mobile terminal 300 related to another embodiment of the present invention.

FIG. 4 is a perspective diagram for one example of a glass type mobile terminal 400 related to further embodiment of the present invention.

FIG. 5 and FIG. 6 are diagrams to describe examples of a method of displaying an indicator corresponding to a payment card in a mobile terminal according to one embodiment of the present invention.

FIGS. 7 to 9 are diagrams to describe examples of displaying a specific indicator in response to occurrence of a specific condition in a mobile terminal according to one embodiment of the present invention.

FIG. 10 is a diagram to describe one example of a method of changing an indicator located at a top side in a state that all indicators corresponding to a plurality of payment cards are displayed in a mobile terminal according to one embodiment of the present invention.

FIG. 11 is a diagram to describe one example of a method of outputting a preset message, if a preset condition is met when a specific situation is recognized, in a mobile terminal according to one embodiment of the present invention.

FIG. 12 is a diagram to describe one example of a method of changing an indicator of a payment card displayed first in a mobile terminal according to one embodiment of the present invention.

FIG. 13 is a diagram to describe one example of a method of changing an indicator corresponding to a payment card displayed first in response to a current location in a mobile terminal according to one embodiment of the present invention.

FIG. 14 is a diagram to describe another example of a method of changing an indicator corresponding to a payment card displayed first in response to a current location in a mobile terminal according to one embodiment of the present invention.

FIG. 15 is a diagram to describe one example of a method of changing an indicator corresponding to a payment card displayed first in response to a use pattern of a plurality of payment cards in a mobile terminal according to one embodiment of the present invention.

FIG. 16 is a diagram to describe one example of a method of changing an indicator corresponding to a payment card displayed first in response to a use pattern of a plurality of payment cards in a mobile terminal according to one embodiment of the present invention.

FIG. 17 is a diagram to describe one example of a method of displaying information on a use limit of each of a plurality of payment cards and information on a use amount of each of a plurality of the payment cards in a mobile terminal according to one embodiment of the present invention.

FIG. 18 is a diagram to describe another example of a method of changing an indicator of a payment card displayed first in a mobile terminal according to one embodiment of the present invention.

FIG. 19 is a diagram to describe another example of a method of changing an indicator of a payment card displayed first in a mobile terminal according to one embodiment of the present invention.

FIG. 20 is a diagram to describe another example of a method of changing an indicator of a payment card displayed first in a mobile terminal according to one embodiment of the present invention.

FIG. 21 is a diagram to describe one example of a method of displaying an indicator corresponding to a specific payment card in response to a current location in a mobile terminal according to one embodiment of the present invention.

FIG. 22 is a diagram to describe one example of a method of displaying an indicator corresponding to a payment card having benefits during a specific period in a mobile terminal according to one embodiment of the present invention.

FIG. 23 is a diagram to describe one example of a method of sending a specific payment card to an external module terminal in a mobile terminal according to one embodiment of the present invention.

FIG. 24 is a diagram to describe one example of a method of upgrading a card level of a specific payment card in a mobile terminal according to one embodiment of the present invention.

FIG. 25 is a diagram to describe another example of a method of upgrading a card level of a specific payment card in a mobile terminal according to one embodiment of the present invention.

FIG. 26 is a diagram to describe one example of a method of displaying an indicator corresponding to a payment card stored in a memory in a mobile terminal according to one embodiment of the present invention.

FIG. 27 is a diagram to describe one example of another method of displaying an indicator corresponding to a payment card stored in a memory in a mobile terminal according to one embodiment of the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with or to” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

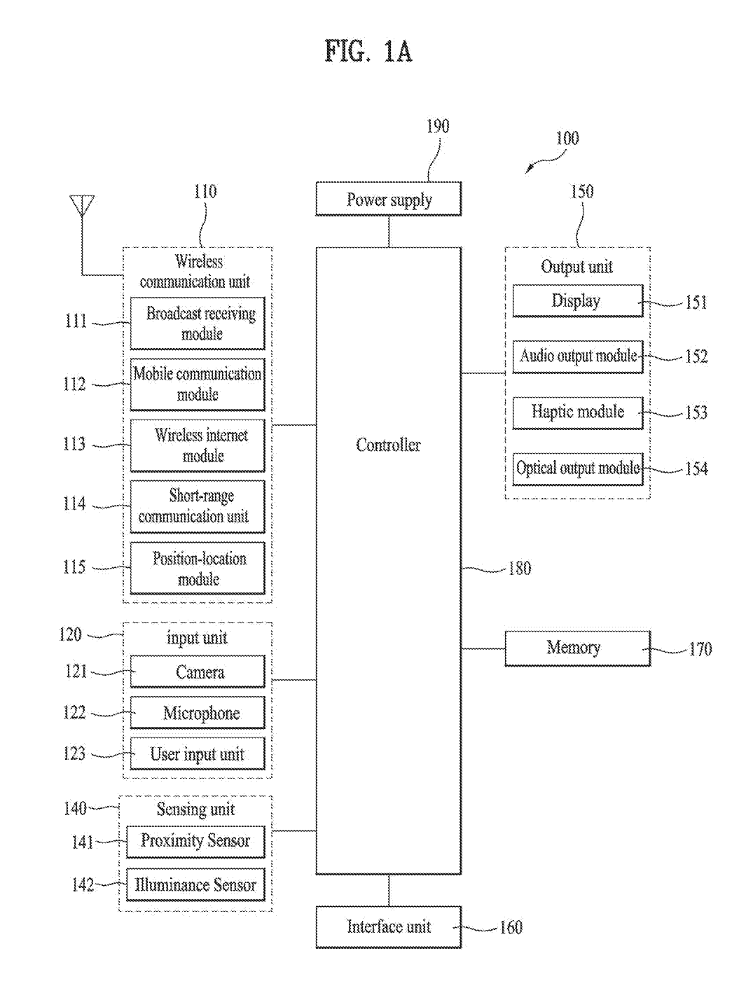

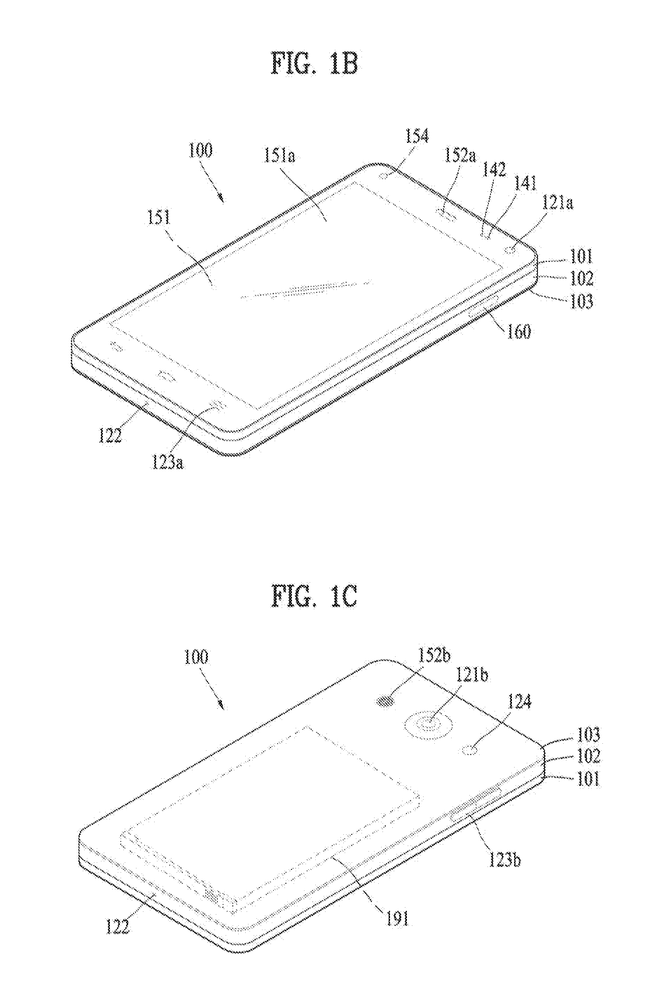

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a position location module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs saved in the memory 170, thereby processing or providing a user with appropriate information and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast management server generates a broadcast signal and/or broadcast-related information, and receives the transmitting server or the generated broadcasting signal and/or broadcasting related information, may refer to a server that transmits to a terminal. The broadcast signal includes a TV broadcast signal, a radio broadcast signal, and a data broadcast signal, as well as a TV broadcast signal or It is also possible to include a broadcast signal in which a data broadcast signal is combined with a radio broadcast signal.

The broadcast signal may be encoded in accordance with technical standards for transmitting and receiving a digital broadcast signal (or a broadcasting system such as ISO, IEC, DVB, ATSC, etc.). And the broadcast receiving module 111 can receive the digital broadcasting signal using method suitable for technical standards.

The broadcast-related information can indicate broadcast channel information, broadcast program information, or broadcast service provider information. The broadcast-related information can be provided via a mobile communication network. In this case, the broadcast-related information can be received by the mobile communication module 112.

The broadcast-related information includes, for example, a DMB (Digital Multimedia Broadcasting), EPG (Electronic Program Guide) or DVB-H (Digital Video Broadcast-Handheld), ESG (Electronic Service Guide), and the like. At least one of broadcast signal and broadcast-related information received through the broadcast receiving module 11 can be stored in the memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The position-location module 115 is generally configured to detect, calculate, derive or otherwise identify a position of the mobile terminal. As an example, the position-location module 115 includes a Global Position System (GPS) module, a Wi-Fi module, or both. If desired, the position-location module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

Generally, 3D stereoscopic images are composed of left image (left eye image) and right image (right eye image). The way the left and right images are combined into a three-dimensional image. Accordingly, a top-down method in which a left image and a right image are arranged vertically in a frame, L-to-R (Left-to-right, side-by-side, left-to-right) method in which a left image and a right image are arranged horizontally in a frame, a checker board method in which pieces of the left and right images are arranged in a tile form, interlaced method in which the left image and the right image are alternately arranged in a column unit or a row unit, time sequential (frame-by-frame) method in which the left and right are alternately displayed by time.

In addition, the 3D thumbnail image is obtained from the left and right images of the original image frame, generates a left-image thumbnail and a right-image thumbnail, respectively, and as they are combined and can be generated as one image. Generally, a thumbnail is a reduced image or a reduced still image. The generated left image thumbnail and right image thumbnail is displayed on the screen by a depth corresponding to the parallax between the left and right images by displaying the difference between the left and right distances, and a three-dimensional spatial feeling can be displayed.

The left and right images required for the implementation of the three-dimensional image are processed by the stereoscopic processing unit, and can be displayed on the stereoscopic display unit. The stereoscopic processing unit receives a 3D image (the image at the criteria point and the image at the expansion point) and sets a left image and a right image from the 3D image, or a 2D image is inputted and converted into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Also, various embodiments can be implemented in the computer and similar recording materials using software, hardware and the combination of software and hardware.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b may also be commonly referred to as a manipulating portion, and may employ any tactile method that allows the user to perform manipulation such as touch, push, scroll, or the like.

The first and second manipulation units 123a and 123b may also employ any non-tactile method that allows the user to perform manipulation such as proximity touch, hovering, or the like.

As another example of the user input unit 123, a rear input unit (not shown) may be located on the rear surface of the terminal body.

The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, in the present invention, it can be displayed using a flexible display. In the following, this will be discussed in more detail with attached drawings.

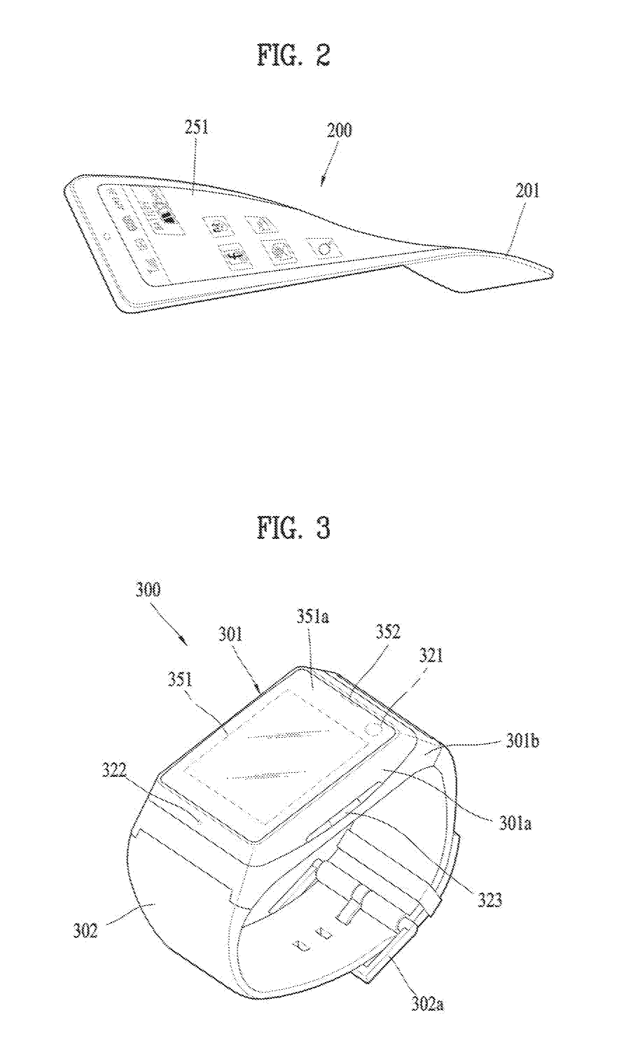

FIG. 2 is a conceptual view to describe another example of a deformable mobile terminal 200 according to the present invention.

Referring to FIG. 2, a display unit 251 may be configured deformable in response to an external force. This deformation may include at last one of curving, bending, folding, twisting, rolling, and combinations thereof. The deformable display unit 251 may be named “flexible display unit”. In particular, the flexible display unit 251 may include a general flexible display, an electronic paper (also known as e-paper), and a combination thereof. In general, a mobile terminal 200 may be configured to include the same or similar features of the former mobile terminal 100 shown in FIGS. 1A to 1C.

Generally, a flexible display means a display that is light-weighted and non-fragile in a manner of being fabricated on a thin and flexible substrate having such properties of paper as curving, bending, folding, twisting, and rolling while maintaining the properties of an existing flat panel display.

The e-paper may be used to refer to a display technology that employs the properties of a general ink. The e-paper is different from the existing flat panel display in using reflective light. The e-paper is generally understood as changing displayed information by electrophoresis using twist balls or capsules.

In a state that the flexible display unit 251 is not deformed (for example, a state that the flexible display unit 251 has an infinite radius of curvature, referred to as a 1^{st} state), a display region of the flexible display unit 251 becomes a flat surface. In a state that the flexible display unit 251 is deformed from the 1^{st} state by an external force (for example, a state that the flexible display unit 251 has a finite radius of curvature, referred to as a 2^{nd} state), the display region may become a curved surface or a bent surface. As illustrated, information displayed in the second state may include a visual information outputted through the curved surface. The visual information may be implemented in a manner that light emission of each unit pixel (sub-pixel) arranged in a matrix configuration is controlled independently. In this case, the unit pixel denotes an elementary unit for representing a single color.

The flexible display unit 251 may enter not a flat state but a curved state (for example, a vertically curved state, a horizontally curved state, etc.) in the 1^{st} state. In doing so, if an external force is applied to the flexible display unit 251, the flexible display unit 251 may be deformed into a flat state (or a less curved state) or a more curved state.

If desired, the flexible display unit 251 may embody a flexible touchscreen by being combined with a touch sensor. If a touch is applied to the flexible touchscreen, the controller 180 (cf. FIG. 1A) can perform a control in response to the touch input. The flexible touchscreen may be configured to sense a touch input not only in the 1^{st} state but also in the 2^{nd} state.

Meanwhile, the mobile terminal 200 according to the modified example may include a deformation sensing means for sensing the deformation of the flexible display unit 251. The deformation sensing means may be included in the sensing unit 140 shown in FIG. 1A.

The deformation sensing means is provided to the flexible display unit 251 or the case 201 to sense information related to the deformation of the flexible display unit 251. Examples of such information related to the deformation of the flexible display unit 251 may include a deformed direction of the flexible display unit 251, a deformed degree of the flexible display unit 251, a deformed position of the flexible display unit 251, a deformed time of the flexible display unit 251, an acceleration for restoring the deformed flexible display unit 251, and the like. Besides, the information may include various kinds of information that can be sensed owing to the curving of the flexible display unit 251.

The controller 180 can change the information displayed on the flexible display unit 251 or generate a control signal for controlling a function of the mobile terminal 200, based on the information related to the deformation of the flexible display unit 251. Such information is typically sensed by the deformation sensing means.

The mobile terminal 200 according to the modified example may include a case 201 for accommodating the flexible display unit 251. The case 201 can be configured deformable together with the flexible display unit 251 in consideration of the property of the flexible display unit 251.

A battery (not shown in the drawing) provided to the mobile terminal 200 may be configured deformable by an external force together with the flexible display unit 251 in consideration of the property of the flexible display unit 251. In order to embody such a battery, it is able to employ a stack and folding scheme of stacking battery cells on each other.

The state deformation of the flexible display unit 251 is non-limited by the case of applying the external force. For example, the flexible display unit 251 can be deformed into the 2^{nd} state in response a command given by a user or application when the flexible display unit 251 is in the 1^{st} state.

Beyond using a mobile terminal grabbed with a user's hand, the mobile terminal may extend to a wearable device that is wearable on a user body. Examples of the wearable device include a smart watch, a smart glass, a head mounted display (HMD), and the like. Examples of the mobile terminal extending to the wearable devices shall be described as follows.

First of all, a typical wearable device can exchange data with (or interwork with) another mobile terminal 100. The short-range communication module 114 can sense or recognize a nearby wearable device capable of communicating with the mobile terminal 100. Moreover, if the sensed wearable device is a device authenticated to communicate with the mobile terminal 100, the controller 180 may transmit at least one portion of the data processed in the mobile terminal 100 to the wearable device via the short-range communication module 114, for example. Hence, a user can use the data processed in the mobile terminal 100 through the wearable device. For example, when an incoming call is received by the mobile terminal 100, the user can answer the incoming call through the wearable device. When a message is received by the mobile terminal 100, the user can check the received message through the wearable device.

FIG. 3 is a perspective diagram for one example of a watch type mobile terminal 300 related to another embodiment of the present invention.

Referring to FIG. 3, a mobile terminal 300 of a watch type may include a main body 301 having a display unit 351 and a band 302 connected to the main body 301 to be wearable on a wrist. In general, the mobile terminal 300 may be configured to include features that are the same or similar to those of the former mobile terminal 100 shown in FIGS. 1A to 1C.

The main body 301 may include a case forming a certain appearance or exterior. As illustrated, the case may include a 1^{st} case 301a and a 2^{nd} case 301b configured to cooperatively provide an inner space for accommodating various electronic components therein, by which the present invention is non-limited. For instance, a single case is configured to provide the inner space, thereby embodying the mobile terminal 300 of a uni-body type.

The watch type mobile terminal 300 is configured to perform wireless communication, and an antenna for the wireless communication can be installed in the main body 301. It is able to expand performance of the antenna using the case. For example, a case containing a conductive material is electrically connected to the antenna to extend a ground region or a radiation region.

The display unit 351 is disposed on the front side of the main body 301 so as to output information. The display unit 351 is provided with a touch sensor so as to be embodied into a touchscreen. As illustrated, a window 351a of the display unit 251 is mounted on the 1^{st} case 301a to form a front surface of the terminal body together with the 1^{st} case 301a.

The main body 301 may be provided with an audio output unit 352, a camera 321, a microphone 322, a user input unit 323 and the like. In case that the display unit 351 is embodiment into the touchscreen, it can function as a user input unit 323. Hence, a separate key may not be provided to the main body 301.

The band 302 is configured to be worn on a wrist by enclosing the wrist. And, the band 302 may be formed of a flexible material for facilitating the wearing of the device. As one example, the band 302 may be made of leather, rubber, silicon, synthetic resin, and/or the like. As the band 302 is configured detachable from the main body 301, the band 302 may be substituted with various types of bands according to a user's preference.

Meanwhile, the band 302 may be used to expand the performance of the antenna. For example, a ground extending portion (not shown in the drawing) for extending a ground region by being electrically connected to the antenna may be built in the band 302.

The band 302 may include a fastener 302a. The fastener 302a may be embodied into a buckle type, a snap-fit hook structure, a Velcro® type, and/or the like. The fastener 302a may include a retractile section or material. According to the example shown in the present drawing, the fastener 302a is embodied into the buckle type.

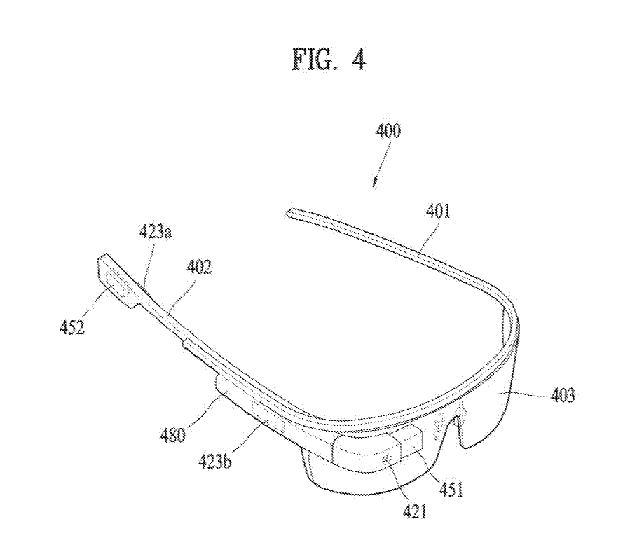

FIG. 4 is a perspective diagram for one example of a glass type mobile terminal 400 related to further embodiment of the present invention.

The glass type mobile terminal 400 is configured wearable on a head of a human body. To this end, the glass type mobile terminal 400 may include a frame unit (e.g., a case, a housing, etc.). The frame unit may be formed of a flexible material to be easily wearable. According to the example shown in the drawing, the frame unit of the mobile terminal 400 includes a 1^{st} frame 401 and a 2^{nd} frame 402, each of which can be made of a different material. In general, the mobile terminal 400 may have the same or similar features of the former mobile terminal 100 shown in FIGS. 1A to 1C.

The frame unit may be supported by the head and provides a space for mounting various components therein. As illustrated, electronic components such as a control module 480, an audio output unit 452 and the like may be installed in the frame unit. And, a lens 403 configured to cover at least one of the left and the right eye may be detachably installed in the frame unit.

The control module 480 is configured to control various electronic components provided to the mobile terminal 400. It may be appreciated that the control module 480 has the configuration corresponding to the aforementioned controller 180. According to the example shown in the present drawing, the control module 480 is installed in the frame unit on one side of the head, by which a location of the control module 480 is non-limited.

The display unit 451 may be embodied into a head mounted display (HMD). The HMD refers to a display system for directly projecting an image in front of user's eyes in a manner of being mounted on the head. In order to provide an image directly in front of the user's eyes, when the user wears the glass type mobile terminal 400, the display unit 451 may be disposed to correspond to at least one of the left eye and the right eye. According to the example shown in the present drawing, the display unit 451 is situated at a location corresponding to the right eye in order to output an image toward the user's right eye.

The display unit 451 may project an image into the user's eye using a prism. And, the prism may be formed to be optically transparent so that the user can watch the projected image and a general visual field (i.e., a range viewed by a user through the corresponding eye) in front of the user.

Thus, the image outputted through the display unit 451 may be viewed in a manner of overlapping the general visual field. The mobile terminal 400 can provide AR (Augmented Reality) by overlaying a virtual image on a real image or a background using the property of the display.

The camera 421 may be disposed adjacent to at least one of the left eye and the right eye to photograph an image in front. Since the camera 421 is situated adjacent to the eye, the camera 421 can obtain an image of a scene currently viewed by the user.

According to the example shown in the preset drawing, the camera 421 is provided to the control module 480, by which the present invention is non-limited. Alternatively, the camera 421 may be installed in the frame unit. Alternatively, a plurality of cameras may be provided to obtain stereoscopic images.

The glass type mobile terminal 400 may include user input units 423a and 423b manipulated to receive an input of a control command. The user input units 423a and 423b may employ any manners (e.g., touch, push, etc.) corresponding to a tactile manner in which a user can perform manipulations by experiencing a tactile sense. According to the example shown in the present drawing, the user input units 423a and 423b of the push input manner and the touch input manner are provided to the frame unit and the control module 480, respectively.

Moreover, the mobile terminal 400 may further include a microphone (not shown in the drawing) for receiving an input of a sound and then processing the input sound into electric audio data and an audio output module 452 for outputting audio. The audio output module 452 may be configured to transfer audio in a general audio output manner or an osteoconductive manner. In case that the audio output unit 452 is embodied in the osteoconductive manner, when the user wears the mobile terminal 400, the audio output unit 452 comes in close contact with a user's head and vibrates user's skull to transfer audio.

A communication system that can be embodied through the mobile terminal 100 according to the present invention is described in detail as follows.

First of all, a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

For clarity, the following description is limited to CDMA only. Yet, it is apparent that the present invention applies equally to other system types including not only CDMA wireless communication system but also OFDM (Orthogonal Frequency Division Multiplexing) wireless communication system.

The CDMA wireless communication system generally includes at least one terminal 100, at least one base station (BS) (possibly named Node B or Evolved Node B), at least one or more base station controllers (BSCs), and a mobile switching center (MSC). The MSC is configured to be connected to a conventional Public Switched Telephone Network (PSTN) and the BSCs. The BSCs are coupled to the base stations to pair with via backhaul line. The backhaul line may be provided in accordance with at least one of E1/T1, ATM, IP, PPP, Frame Relay, HDSL, ADSL, and xDSL. Hence, a plurality of BSCs can be included in the CDMA wireless communication system.

Each of a plurality of BSs (base stations) may include at least one or more sectors. And, each of the sectors may include an omni-directional antenna or an antenna indicating a specific direction radially away from the BS. Alternatively, each of the sectors may include two or more antennas of various types. Each of the BSs may be configured to support a plurality of frequency assignments. And, each of a plurality of the frequency assignments may have a specific spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In this case, the term “base station” may be used to refer collectively to one BSC and at least one BS. The base stations may indicate “cell site.” Moreover, each of a plurality of sectors for a specific BS may be referred to as a plurality of cell sites.

A broadcasting transmitter (BT) transmits a broadcast signal to the mobile terminals 100 operating within the system. The broadcast receiving module 111 shown in FIG. 1A is typically configured inside the mobile terminal 100 to receive broadcast signals transmitted by the BT.

Moreover, Global Positioning System (GPS) for locating the position of the mobile terminal 100 may cooperate with the CDMA wireless communication system. The satellite 300 helps to obtain a location of the mobile terminal 100. Useful position information may be obtained with greater or fewer satellites than two. In doing so, it is able to trace a location of the mobile terminal 100 using all technologies capable of tracing locations or positions as well as the GPS tracking technology. If desired, at least one of the GPS satellites may be in charge of satellite DMB transmissions optionally or additionally.

The location information module 115 provided to the mobile terminal is generally configured to detect, calculate, or otherwise identify a position or location of the mobile terminal. As a representative example, the location information module 115 may include a Global Position System (GPS) module, a Wi-Fi (wireless fidelity) module, or both. If desired, the location information module 115 may alternatively or additionally function as any of the other modules of the wireless communication unit 110 to obtain data related to the position or location of the mobile terminal.

The GPS module 115 accurately calculates a current 3D location information according to latitude, longitude and latitude by measuring an accurate time and distance from three or more satellites and then applying trigonometry to the calculated informations. Currently, a method of acquiring distance and time information from three satellites and performing error correction with a single satellite is popularly used. Moreover, the GPS module 115 can acquire speed information by continuing to calculate a real-time current location. Yet, accuracy of a measured location or position of the mobile terminal may be compromised when the mobile terminal is located in such a blind spot of satellite signals as an indoor space or the like. In order to compensate the measured location by GPS system, it is able to use Wi-Fi Positioning System (WPS) and the like.

The Wi-Fi positioning system (WPS) is the location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal 100, a wireless access point (AP) connected to the mobile terminal 100, and a database storing random wireless AP information.

The mobile terminal 100 currently connected to the wireless AP may send a location information request message to the Wi-Fi location determination server.

The Wi-Fi location determination server extracts the information of the wireless AP connected to the mobile terminal 100, based on the location information request message (or signal) of the mobile terminal 100. The information of the wireless AP connected to the mobile terminal 100 may be sent to the Wi-Fi location determination server through the mobile terminal 100, or sent to the Wi-Fi location determination server from the wireless AP.

The information of the wireless AP extracted based on the location information request message of the mobile terminal 100 may include at least one of media access control (MAC) address, service set identification (SSID), received signal strength indicator (RSSI), reference signal received Power (RSRP), reference signal received quality (RSRQ), channel information, privacy, network type, signal strength, noise strength, and the like.

As mentioned in the above description, the Wi-Fi location determination server receives the information of the wireless AP connected to the mobile terminal 100 and may be then able to extract wireless AP information corresponding to the wireless AP connected to the mobile terminal from the pre-established database. In this case, the information of any wireless APs stored in the database may include information such as MAC address, SSID, RSSI, channel information, privacy, network type, latitude and longitude coordinate, building at which the wireless AP is located, floor number, detailed indoor location information (GPS coordinates available), AP owner's address, phone number, and the like. In doing so, in order to remove a mobile AP or a wireless AP provided using an illegal MAC address in the course of a location determining process, the Wi-Fi location determination server may extract only a prescribed number of wireless AP informations in order of high RSSI.

Thereafter, the Wi-Fi location determination server may extract (analyze) location information of the mobile terminal 100 using at least one wireless AP information extracted from the database. By comparing the included information and the received wireless AP information to each other, the location information of the mobile terminal 100 is extracted (or analyzed).

As a method for extracting (or analyzing) the location information of the mobile terminal 100, it is able to utilize a Cell-ID scheme, a fingerprint scheme, a trigonometry scheme, a landmark scheme and the like.

The Cell-ID scheme is used to determine a location of a wireless AP having the largest signal strength among peripheral wireless AP informations collected by a mobile terminal as a location of the mobile terminal. The Cell-ID scheme has advantages as follows. First of app, Implementation of the Cell-ID scheme is minimally complicated. Secondly, the Cell-ID scheme does not require additional costs. Thirdly, location information can be rapidly acquired. Yet, the Cell-ID scheme has the disadvantage in that the precision of positioning may fall below a desired threshold when the installation density of wireless APs is low.

The fingerprint scheme is a method of estimating a location through a signal strength information transmitted by a mobile terminal based on information collected by selecting a reference location from a service area. In order to use the fingerprint scheme, it is necessary to establish database of propagation characteristics in advance.

The trigonometry scheme is used to calculate a location of a mobile terminal based on a distance between coordinates of at least three wireless APs and the mobile terminal. In order to measure the distances between the mobile terminal and the wireless APs, signal strength may be converted into distance information, or Time of Arrival (ToA), Time Difference of Arrival (TDoA), Angle of Arrival (AoA) and the like may be used.

The landmark scheme is used to measure a location or position of a mobile terminal using a known landmark transmitter.

In addition to the above-listed schemes, various algorithms may be used to extract (or analyze) location information of a mobile terminal.

Such extracted location information may be transmitted to the mobile terminal 100 through the Wi-Fi location determination server, whereby the mobile terminal can acquire the location information.

The mobile terminal 100 can acquire location information by being connected to at least one wireless AP. In doing so, the number of wireless APs required for acquiring the location information of the mobile terminal 100 may be variously changeable depending on a wireless communication environment in which the mobile terminal 100 is situated.

As mentioned in the foregoing description with reference to FIG. 1A, short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus) and the like may apply to the mobile terminal according to the present invention.

Among the short-range communication technologies, NFC module provided to the mobile terminal supports an inter-terminal non-contact type short-range wireless communication in a distance of about 10 cm range. The NFC module may operate in one of a card mode, a reader mode and a P2P mode. The mobile terminal 100 may further include a security module for storing card information in order to for the NFC module in the card mode. In this case, the security module may include one of a physical medium such as Universal Integrated Circuit Card (UICC) (e.g., Subscriber Identification Module (SIM), Universal SIM (USIM), etc.), Secure micro SD, a sticker and the like, or a logical medium (e.g., embedded Secure Element (SE), etc.) embedded in the mobile terminal. Data exchange may be performed between the NFC module and the security module based on Single Wire Protocol (SWP).

In a case that the NFC module operates in the card mode, the mobile terminal may externally transfer card information saved like a traditional IC card. In particular, if a mobile terminal storing card information of a payment card (e.g., a credit card, a bus card, etc.) approaches a card reader, a short-range mobile payment may be processed. If a mobile terminal storing card information of an entrance card approaches an entrance card reader, an entrance approval procedure may start. A card such as a credit card, a traffic card, or an entrance card may be loaded on the security module in the form of applet, and the security module may store card information on the loaded card. In this case, the card information of the payment card may include at least one of a card number, a remaining amount, a use history, and the like. The card information of the entrance card may include at least one of a user's name, a user's number (e.g., a user's student number, a user's staff number, etc.), an entrance history, and the like.

In case that the NFC module operates in the reader mode, the mobile terminal can read data from an external tag. In doing so, the data received from the external tag by the mobile terminal may be coded in NFC Data Exchange Format defined by NFC Forum. And, the NFC Forum generally defines four record types. In particular, the NFC Forum defines four Record Type Definitions (RTDs) such as Smart Poster, Text, Uniform Resource Identifier (URI), General Control and the like. If the data received from the external tag is a smart poster type, the controller can run a browser (e.g., Internet browser, etc.). If the data received from the external tag is a text type, the controller can run a text viewer. If the data received from the external tag is a URI type, the controller can run a browser or make a phone call. If the data received from the external tag is a general control type, the controller can execute an accurate operation in accordance with control contents.

In case that the NFC module operates in the P2P (Peer-to-Peer) mode, the mobile terminal can perform P2P communication with another mobile terminal. In this case, Logical Link Control Protocol (LLCP) can apply to the P2P communication. For the P2P communication, connection may be created between one mobile terminal and another mobile terminal. In this case, the connection may be categorized into a connectionless mode terminated after switching a single packet or a connection-oriented mode for exchanging packets consecutively. Through the P2P communication, data such as an electronic type business card, a contact information, a digital photo, a URL and the like, setup parameters for Bluetooth connection, Wi-Fi connection, etc. can be exchanged. Yet, the P2P mode can be effectively utilized in exchanging data in small size because an available distance for the NFC communication is relatively short.

Embodiments related to a controlling method implemented in the above-configured mobile terminal shall be described in more detail with reference to the accompanying drawings. It is understood by those skilled in the art that the present features can be embodied in several forms without departing from the characteristics thereof.

In the following description, embodiments of the present specification shall be described by taking the mobile terminal 100 shown in FIG. 1A as one example. Yet, it is a matter of course that a mobile terminal according to one embodiment of the present invention can be embodied with the mobile terminals 200, 300 and 400 shown in FIGS. 2 to 4.

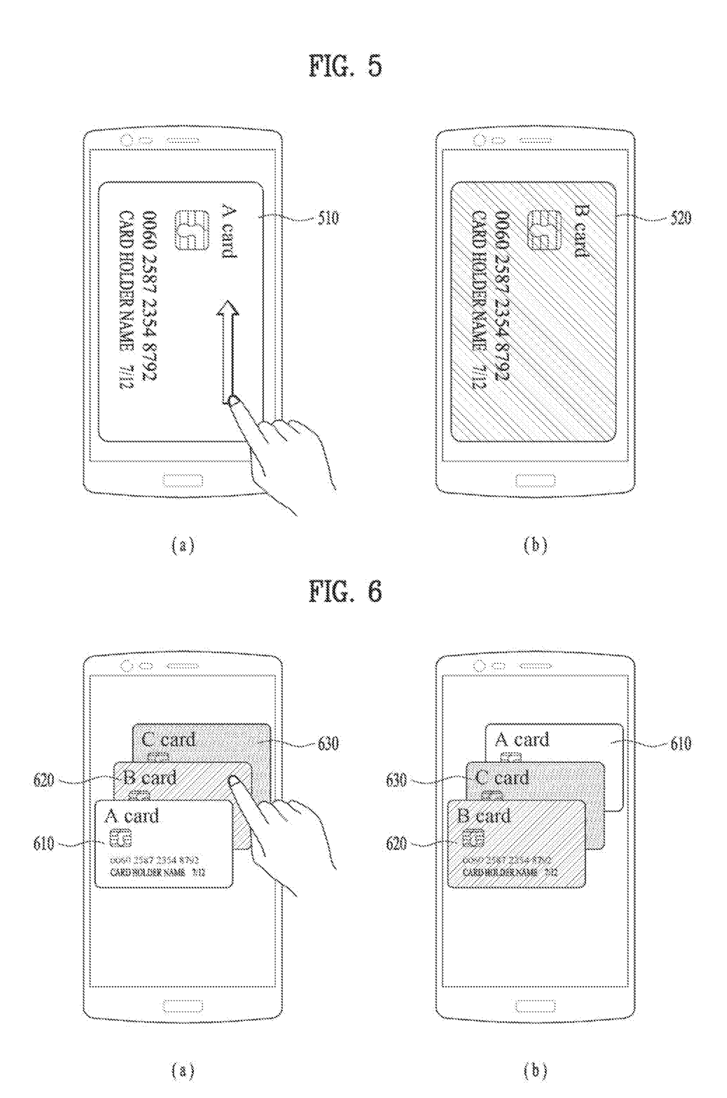

In the following description, a method of displaying an indicator corresponding to a payment card stored in a memory in a mobile terminal 100 according to one embodiment of the present invention shall be described with reference to FIGS. 5 to 27.

FIG. 5 and FIG. 6 are diagrams to describe examples of a method of displaying an indicator corresponding to a payment card in a mobile terminal according to one embodiment of the present invention.

According to one embodiment of the present invention, identification information for identifying each of a plurality of payment cards can be stored in the memory 170. Here, a plurality of the payment cards may include a check card, a credit card, a prepaid card, and the like, which are shown or presented for payment.

For example, if a user inputs information on a card owned by the user to the mobile terminal 100, identification information for identifying each of a plurality of the payment cards can be saved to the memory 170.

For another example, if a user inputs user's personal information (e.g., date of birth, phone number, etc.), the controller 180 can send the personal information to a specific external server (e.g., a card company server). The controller 180 may receive identification information for identifying each of cards owned by the user from the specific external server. And, the controller 180 can save the received identification information to the memory 170.

If a preset condition is met, the controller 180 can control the display unit 151 to display an indicator corresponding to each of a plurality of the payment cards based on the identification information.

For example, if recognizing that the mobile terminal 100 is located at a preset place, the controller 180 can control the display unit 151 to display an indicator corresponding to each of a plurality of the payment cards based on the identification information.

For another example, if a user of the mobile terminal 100 launches a preset application, the controller 180 can control the display unit 151 to display an indicator corresponding to each of a plurality of the payment cards based on the identification information.

For another example, while a home screen is displayed, if a specific touch gesture is inputted, the controller 180 can control the display unit 151 to display an indicator corresponding to each of a plurality of the payment cards based on the identification information.

For further example, if recognizing that communication with a preset external terminal (e.g., a payment terminal) is connected, the controller 180 can control the display unit 151 to display an indicator corresponding to each of a plurality of the payment cards based on the identification information.

The controller 180 can control the display unit 151 to display an indicator corresponding to each of a plurality of the payment cards based on the identification information.

For example, referring to FIG. 5 (a), when the indicator corresponding to each of a plurality of the payment cards is displayed, the controller 180 can display the indicators one by one. In this case, the controller 180 can control the display unit 151 to first display a first indicator 510 corresponding to a first payment card. Here, the first payment card may include a payment card corresponding to an indicator selected by a user so as to be displayed first when the indicator corresponding to each of a plurality of the payment cards is displayed. For example, if a user presets an A card to be displayed first, as the preset condition is met, the controller 180 can control the display unit 151 to display the indicator 510 of the A card.

For another example, referring to FIG. 6 (a), the controller 180 can control the display unit 151 to display all indicators of a plurality of the payment cards. In this case, the controller 180 can control the display unit 151 to display an indicator corresponding to a first payment card at a specific location. Here, the first payment card may include a payment card corresponding to an indicator selected by a user so as to be displayed first when the indicator corresponding to each of a plurality of the payment cards is displayed. And, the specific location may include a location seen first when a user looks at the indicators respectively corresponding to a plurality of the payment cards. Namely, when the user looks at the indicator of each of a plurality of the payment cards, the specific location may include the location recognized as located at a top position by the user. For example, if a user presets an A card to be displayed first, as the preset condition is met, the controller 180 can control the display unit 151 to display the indicator 610 corresponding to the A card in a manner that the indicator 610 is located above indicators 620 and 630 corresponding to other cards.

Meanwhile, according to one embodiment of the present invention, the controller 180 can control the display unit 151 to display a second indicator corresponding to a second payment card in response to a specific command. Here, the second payment card is a payment card different from the first payment card.

For example, referring to FIG. 5 (b), while the first indicator 510 is displayed on the display unit 151 only in FIG. 5 (a), in response to a touch command of touching a prescribed region having the first indicator 510 displayed thereon and then dragging in a specific direction (e.g., a top direction), the controller 180 can control the display unit 151 to display the second indicator 520 corresponding to the second payment card.

For another example, referring to FIG. 6 (b), while indicators 610, 620 and 630 respectively corresponding to a plurality of payment cards are displayed, in response to a touch command of touching a prescribed region on which a second indicator 630 corresponding to a second payment card is displayed, the controller 180 can control the display unit 151 to display the second indicator 620 corresponding to the second payment card above the indicators 610 and 630 corresponding to other cards.

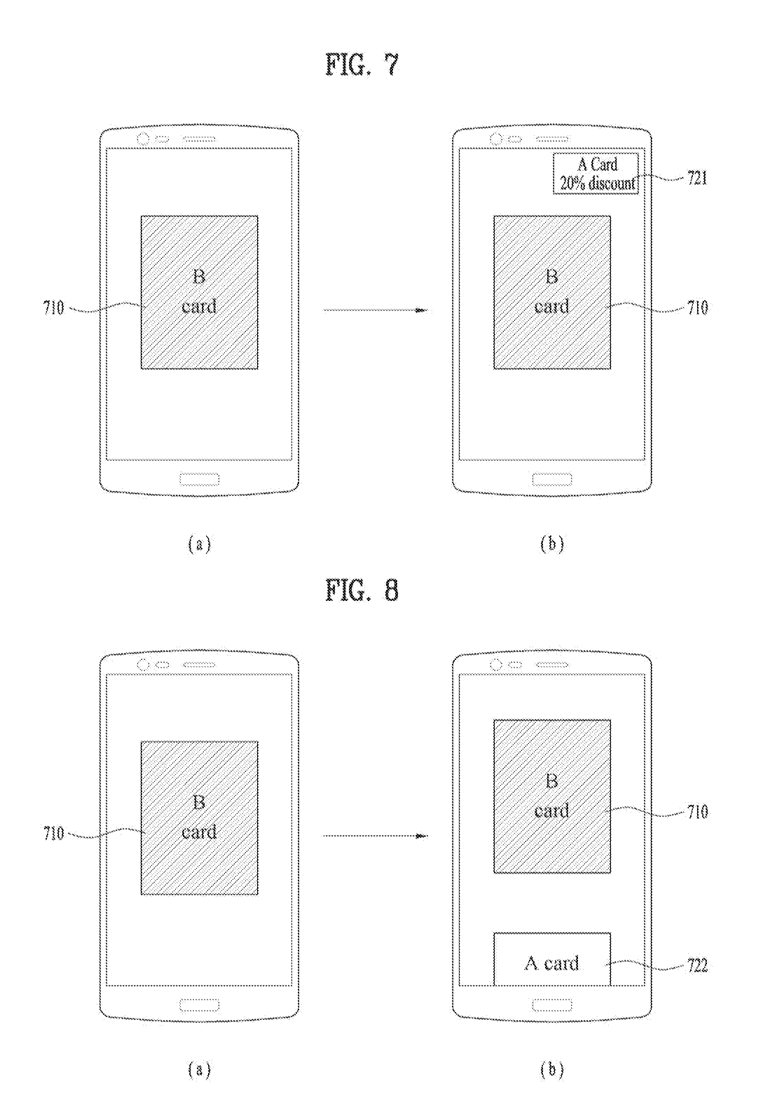

Meanwhile, according to one embodiment of the present invention, while a first indicator corresponding to a first payment card is displayed only, the controller 180 can control the display unit 151 to display a specific indicator in response to an occurrence of a specific condition. This is described in detail with reference to FIGS. 7 to 9.

FIGS. 7 to 9 are diagrams to describe examples of displaying a specific indicator in response to occurrence of a specific condition in a mobile terminal according to one embodiment of the present invention. Regarding FIGS. 7 to 9, the substance redundant with the foregoing description with reference to FIG. 5 and FIG. 6 will not be described but the following description shall be made centering on differences.

According to one embodiment of the present invention, identification information for identifying each of a plurality of payment cards may be stored in the memory 170 in advance.

The controller 180 can control the wireless communication unit to receive benefit information corresponding to card benefits of each of a plurality of the payment cards from an external server.

Particularly, based on the identification information, the controller 180 can obtain card company information if each of a plurality of the payment cards. And, using the card company information, the controller 180 can control the wireless communication unit to receive benefit information corresponding to card benefits of each of a plurality of the payment cards from a server of the corresponding card company.

The benefit information may include information on a discount receivable in case of a user's use of a payment card (e.g., information indicating that a specific product is purchasable at the 10% discounted price in case of purchasing the specific product using A card at a specific shop in a specific period), information on a promotion related to the payment card (e.g., information on a gift provided in case of using A card in a specific period), etc.

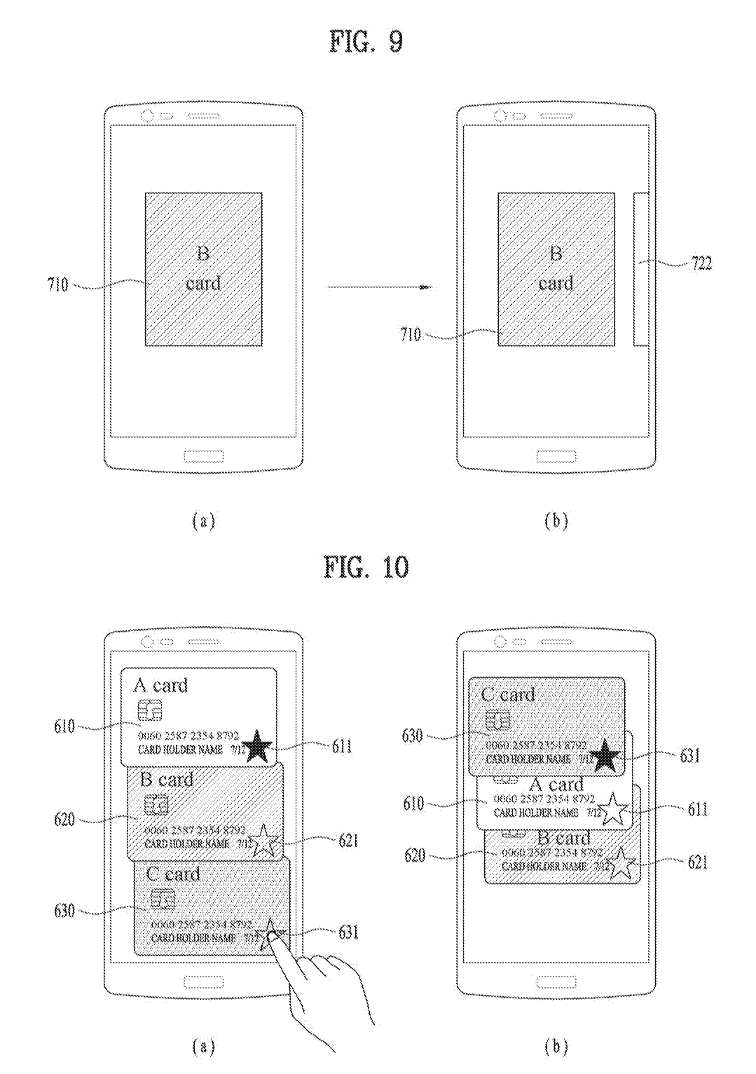

Meanwhile, referring to FIG. 7 (a), FIG. 8 (a) and FIG. 9 (a), the controller 180 displays an indicator corresponding to each of a plurality of the payment cards based on the identification information and is also able to control the display unit 151 to first display a first indicator 710 corresponding to a first payment card. Here, the first payment card may include a payment card corresponding to an indicator selected by a user so as to be displayed first when the indicator corresponding to each of a plurality of the payment cards is displayed.

For example, if a user sets B card as a payment card to be displayed first among a plurality of the payment cards stored in the memory 170, the controller 180 can control the display unit 151 to first display the first indicator 710 corresponding to the B card when the indicator of each of a plurality of the payment cards stored in the memory 170 is displayed.

Meanwhile, the controller 180 can control the display unit 151 to display a specific indicator in response to an occurrence of a specific condition while the first indicator 710 is displayed. The occurrence of the specific condition may include a case that a payment card having the highest card benefit rank among a plurality of the payment cards is recognized as a second payment card instead of the first payment card.

Particularly, algorithm for determining the card benefit ranks may be stored in the memory 170. Hence, the controller 180 can recognize benefit information corresponding to each of the card benefit ranks of a plurality of the payment cards based on the benefit information. If recognizing that a payment card having the highest card benefit rank among a plurality of the payment cards is the second payment card instead of the first payment card based on the benefit information, the controller 180 can control the display unit 151 to display the specific indicator.

For example, referring to FIG. 7 (b), in response to the occurrence of the specific condition, the controller 180 can control the display unit 151 to display an indicator 721 indicating information of the second payment card on a prescribed region. For example, the information of the second payment card may include information indicating that a card type is A card and information indicating that a payment can be made at a 20% discounted price in case of using the A card.

For another example, referring to FIG. 8 (b), in response to the occurrence of the specific condition, the controller 180 can control the display unit 151 to display a second indicator 722 corresponding to the second payment card below the first indicator 710 corresponding to the first payment card.

For another example, referring to FIG. 9 (b), in response to the occurrence of the specific condition, the controller 180 can control the display unit 151 to display the second indicator 722 on a right side of the first indicator 710.

The present invention is non-limited by the above examples. In response to the occurrence of the specific condition, the controller 180 can control the display unit 151 to display the second indicator 722 above or on a left side of the first indicator 710.

Meanwhile, according to one embodiment of the present invention, if detecting a command for selecting the specific indicators 721 and 722, the controller 180 can control the display unit 151 to display the second indicator corresponding to the second payment car instead of the first indicator corresponding to the first payment card.

Meanwhile, according to one embodiment of the present invention, after detecting a command for selecting the specific indicators 721 and 722, the controller 180 can control the display unit 151 to first display the second indicator corresponding to the second payment card when displaying the indicator corresponding to each of a plurality of the payment cards. Namely, a user selects the specific indicators 721 and 722, thereby changing the indicator, which is displayed first when the indicator corresponding to each of a plurality of the payment cards is displayed, into the second indicator from the first indicator. In this case, when the indicator corresponding to each of a plurality of the payment cards is displayed, the controller 180 may output a message for confirming whether to first display the second indicator corresponding to the second payment card.

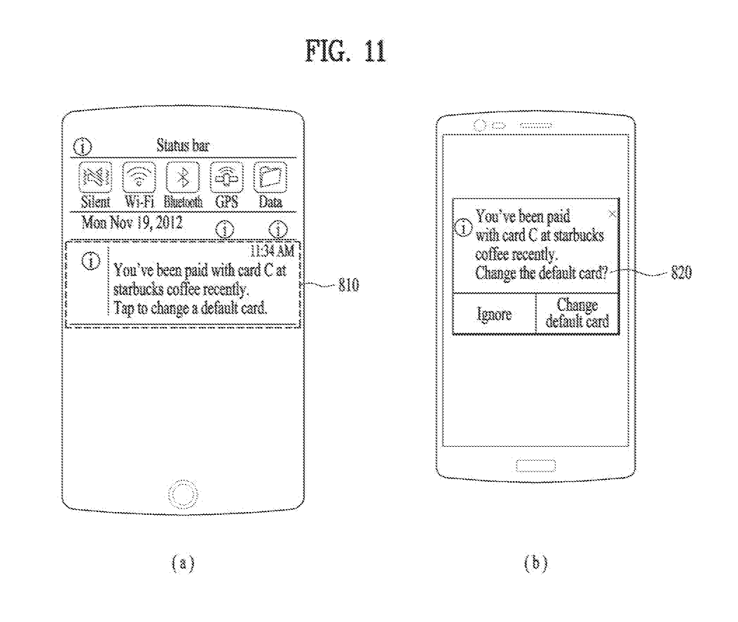

Meanwhile, according to one embodiment of the present invention, while all the indicators corresponding to a plurality of the payment cards are displayed, the controller 180 can change an indicator located at a top side in response to a user's specific command. This is described in detail with reference to FIG. 10.

FIG. 10 is a diagram to describe one example of a method of changing an indicator located at a top side in a state that all indicators corresponding to a plurality of payment cards are displayed in a mobile terminal according to one embodiment of the present invention. Regarding FIG. 10, the substance redundant with the foregoing description with reference to FIGS. 5 to 9 will not be described but the following description shall be made centering on differences.

According to one embodiment of the present invention, the memory 170 can store identification information for identifying each of a plurality of payment cards. Based on the identification information, the controller 180 can control the display unit 151 to display an indicator corresponding to each of a plurality of the payment cards. Here, when the indicator corresponding to each of a plurality of the payment cards is displayed, a first indicator 610 corresponding to a first payment card selected by a user can be displayed at a location to enable the user to recognize that the first indicator 610 is located above other indicators 620 and 630.

Meanwhile, referring to FIG. 10 (a), the indicators 610, 620 and 630 corresponding to a plurality of the payment cards may include check boxes 611, 621 and 631, respectively. Here, the check boxes 611, 621 and 631 may have star shapes, by which the present invention is non-limited. And, the check boxes 611, 621 and 631 may have various shapes.

The controller 180 can control the display unit 151 to give a preset visual effect to the check box 611 included in the indicator (e.g., first indicator 610) located at the top side among the check boxes 611, 621 and 631. For example, the preset visual effect may include an effect of filling an inside of the check box 611 with specific color, by which the present invention is non-limited.

Meanwhile, the controller 180 may detect a touch command for selecting a prescribed one (e.g., third check box 631) of the check boxes 621 and 631 included in the indicators 620 and 630 other than the first indicator 610.

Referring to FIG. 10 (b), in response to the touch command, the controller 180 can control the display unit 151 to display the third indicator 630, which corresponds to the third check box 631 having the touch command detected therefrom, on a top side.

In this case, the controller 180 can release the visual effect given to the check box 611 included in the first indicator 610 and give the visual effect to the check box 631 included in the third indicator 630.

Meanwhile, according to one embodiment of the present invention, when a specific situation is recognized, if a preset condition is met, the controller 180 can control the display unit 151 to output a preset message. This is described in detail with reference to FIG. 11.

FIG. 11 is a diagram to describe one example of a method of outputting a preset message, if a preset condition is met when a specific situation is recognized, in a mobile terminal according to one embodiment of the present invention. Regarding FIG. 11, the substance redundant with the foregoing description with reference to FIGS. 5 to 10 will not be described but the following description shall be made centering on differences.

According to one embodiment of the present invention, the memory 170 can store identification information for identifying each of a plurality of cards.

The controller 180 can save pattern information on a use pattern of each of a plurality of the payment cards to the memory 170.

Particularly, if payments are made using a plurality of the payment cards, the controller 180 can save a use history of the payment cards used for the payments to the memory 170. The controller 180 recognizes a use pattern of each of a plurality of the payment cards using the use history of the payment cards used for the payments and is able to save the recognized use pattern as pattern information to the memory 170. Here, the pattern information may include information on a payment card frequently used in a specific time slot among a plurality of the payment cards, information on a payment card used frequently at a specific place among a plurality of the payment cards, etc.

The controller 180 can control the wireless communication unit 110 to receive benefit information corresponding to card benefits of each of a plurality of the payment cards.

The controller 180 can control the location information module 115 to obtain location information on a current location of the mobile terminal.

Meanwhile, when an indicator corresponding to each of a plurality of the payment cards is displayed based on the identification information, if a preset condition is met, the controller 180 can output a preset message.

First of all, if recognizing a preset touch input, the controller 180 can recognize it as a situation that a user should submit a payment card. And, in the recognized situation, the controller 180 can control the display unit 151 to display an indicator corresponding to each of a plurality of the payment cards based on the identification information.

For example, if detecting a preset touch input, the controller 180 may recognize it as a situation that the user should submit a payment card.

For another example, if communication is connected between the mobile terminal 100 and an external payment terminal, the controller 180 may recognize it as a situation that the user should submit a payment card.

For further example, if obtaining an image (e.g., image containing a QR code) containing a specific indication through the camera 121, the controller 180 may recognize it as a situation that the user should submit a payment card.

And, when an indicator of each of a plurality of the payment cards is displayed, if an output priority of a first payment card is higher than that of a second payment card, the controller 180 can recognize that the preset condition is met. Here, the first payment card may include a payment card corresponding to an indicator selected by a user so as to be displayed first when the indicator corresponding to each of a plurality of the payment cards is displayed. And, the second payment card may include a payment card other than the first payment card.

Particularly, based on at least one of the identification information, the pattern information, the benefit information and the location information, the controller 180 can recognize rank information corresponding to an output priority of each of a plurality of the payment cards. Based on the rank information, if recognizing that a payment card having a highest output priority among a plurality of the payment cards is not the first payment card but the second payment card, the controller 180 can control the display unit 151 to output the preset message. In the memory 170, algorithm for detecting output priorities of a plurality of the payment cards may be stored in advance.

For example, referring to FIG. 11 (a), if recognizing that it is paid using a C card at a specific location (e.g., Starbucks Coffee) based on the pattern information, the controller 180 can recognize that the C card is a payment card having a highest output priority. And, the controller 180 can control the display unit 151 to display a message 810 for checking whether to first display the second indicator corresponding to the second payment card instead of the first indicator on a status window.

In the message 810, the substance for checking whether to change a default card may be contained. And, the default card means a payment card corresponding to an indicator displayed first when an indicator corresponding to each of a plurality of the payment cards is displayed.

For example, referring to FIG. 11 (b), if recognizing that it is paid using a C card at a specific location (e.g., Starbucks Coffee) based on the pattern information, the controller 180 can recognize that the C card is a payment card having a highest output priority. And, the controller 180 can control the display unit 151 to display a popup message 820 for checking whether to first display the second indicator corresponding to the second payment card instead of the first indicator.

In the popup message 820, the substance for checking whether to change a default card may be contained. And, the default card means a payment card corresponding to an indicator displayed first when an indicator corresponding to each of a plurality of the payment cards is displayed.

Meanwhile, if detecting a command for setting the second indicator as an indicator corresponding to a payment card to be displayed first instead of the first indicator through the message 810/820, the controller 180 can control the display unit 151 to display the second indicator first instead of the first indicator when displaying an indicator corresponding to each of a plurality of the payment cards.

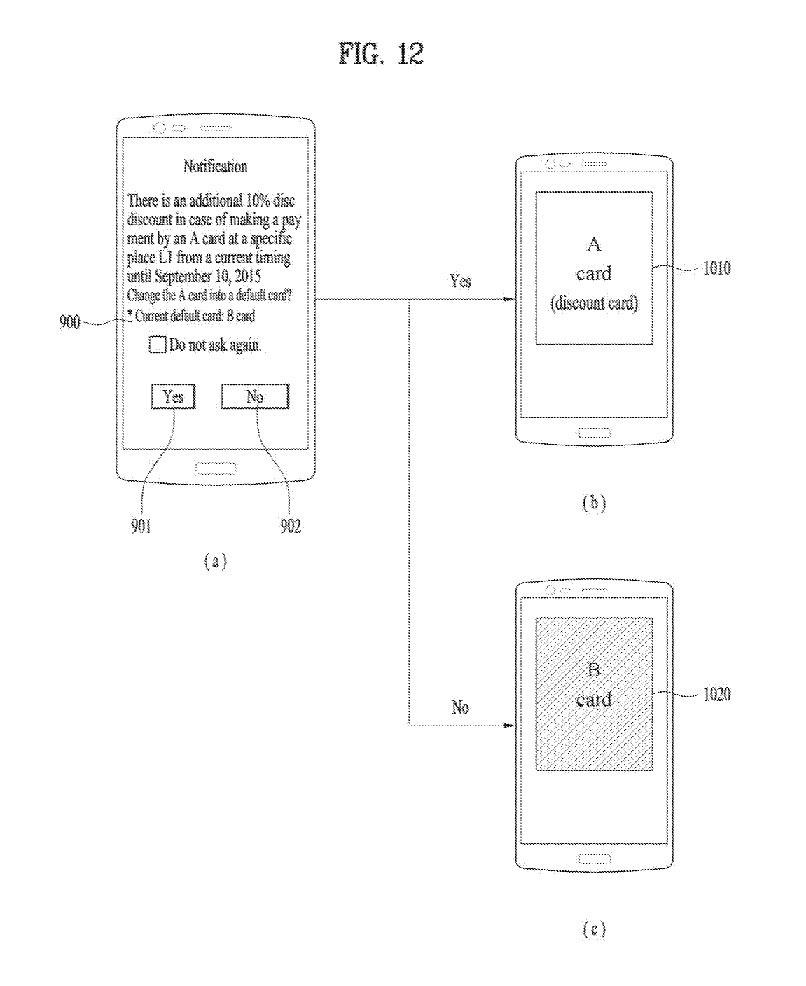

Meanwhile, according to one embodiment of the present invention, when there exists a card benefit in case of using a specific card for a specific period at a specific place, a user can set an indicator, which corresponds to the specific card, to be displayed first. This is described in detail with reference to FIG. 12.

FIG. 12 is a diagram to describe one example of a method of changing an indicator of a payment card displayed first in a mobile terminal according to one embodiment of the present invention. Regarding FIG. 12, the substance redundant with the foregoing description with reference to FIGS. 5 to 11 will not be described but the following description shall be made centering on differences.

According to one embodiment of the present invention, the memory 10 can store identification information for identifying each of a plurality of payment cards. The controller 180 can control the wireless communication unit 110 to receive benefit information corresponding to card benefits of each of a plurality of the payment cards from an external server. When the controller 180 displays an indicator corresponding to each of a plurality of the payment cards based on the identification information, the controller 180 can control the display unit 151 to first display a first indicator corresponding to a first payment card (e.g., a B card).

Referring to FIG. 12 (a), if card benefits exist in a specific card during a specific period at a specific place, the controller 180 can display a message 900 for changing a payment card displayed first among indicators respectively corresponding to a plurality of the payment cards.

Particularly, the controller 180 can control the wireless communication unit 110 to receive benefit information on a payment card having benefits during the specific period from the external server. For example, the controller 180 can control the wireless communication unit 110 to receive the benefit information, which indicates that there is 10% discount in case of making a payment by an A card at a specific place L1 from a current timing until Sep. 10, 2015, from the external server.

The controller 180 can control the location information module 115 to obtain location information on a current location of the mobile terminal 100. Based on the benefit information and the location information, if recognizing that a second payment card (e.g., A card) is a payment card having benefits at the current location, the controller 180 can control the display unit 151 to display a message 900 for checking whether to display a second indicator corresponding to the second payment card instead of the first indicator.

For example, if recognizing that a current location is the specific place L1 based on the location information and that a current timing is before Sep. 10, 2015, the controller 180 can control the display unit 151 to display the message 900 for checking whether to change an indicator, which is displayed first when an indicator corresponding to each of a plurality of the payment cards is displayed, into the A card.

In the message 900, the substance for checking whether to change a default card may be contained. Here, the default card means a payment card corresponding to an indicator displayed first when an indicator corresponding to each of a plurality of the payment cards is displayed.

Referring to FIG. 12 (b), if detecting a first command (e.g., command for selecting a first region 901 included in the message 900) through the message 900, the controller 180 can control the display unit 151 to first display a second indicator 1010 instead of the first indicator 1020 when an indicator corresponding to each of a plurality of the payment cards is displayed. Namely, in response to the first command, the controller 180 can control the display unit 151 to display the second indicator 1010 first instead of the first indicator 1020 when an indicator corresponding to each of a plurality of the payment cards is displayed in the future.

Yet, referring to FIG. 12 (c), in response to a second command for selecting a second region 902 included in the message 900, the controller 180 can control the display unit 151 to first display the first indicator 1020 corresponding to the first payment card when an indicator corresponding to each of a plurality of the payment cards is displayed. Namely, a user enables an indicator, which is displayed first when an indicator corresponding to each of a plurality of the payment cards is displayed, to be maintained intact.

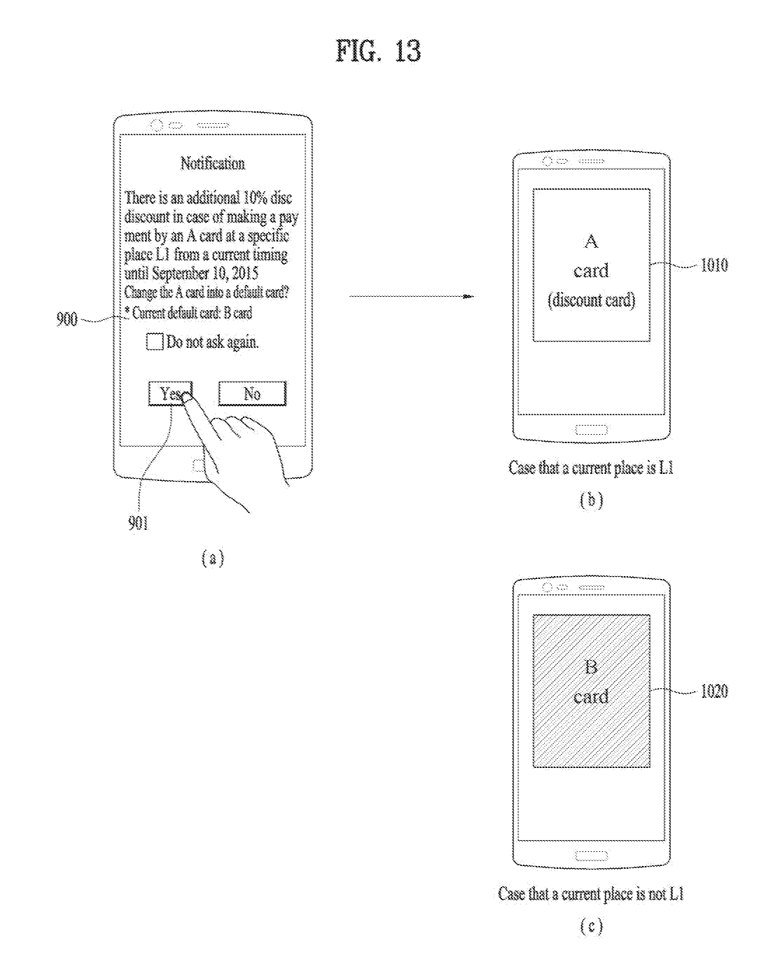

Meanwhile, according to one embodiment of the present invention, the controller 180 may change an indicator corresponding to a payment card displayed first according to a current location of the mobile terminal 100. This is described in detail with reference to FIG. 13.

FIG. 13 is a diagram to describe one example of a method of changing an indicator corresponding to a payment card displayed first in response to a current location in a mobile terminal according to one embodiment of the present invention.

According to one embodiment of the present invention, the memory 10 can store identification information for identifying each of a plurality of payment cards. The controller 180 can control the wireless communication unit 110 to receive benefit information corresponding to card benefits of each of a plurality of the payment cards from an external server. When the controller 180 displays an indicator corresponding to each of a plurality of the payment cards based on the identification information, the controller 180 can control the display unit 151 to first display a first indicator corresponding to a first payment card (e.g., a B card).

Referring to FIG. 13 (a), if card benefits exist in a specific card during a specific period at a specific place, the controller 180 can display a message 900 for changing a payment card displayed first among indicators respectively corresponding to a plurality of the payment cards.

Particularly, the controller 180 can control the wireless communication unit 110 to receive benefit information on a payment card having benefits during the specific period from the external server. For example, the controller 180 can control the wireless communication unit 110 to receive the benefit information, which indicates that there is 10% discount in case of making a payment by an A card at a specific place L1 from a current timing until Sep. 10, 2015, from the external server.

The controller 180 can control the location information module 115 to obtain location information on a current location of the mobile terminal 100. Based on the benefit information and the location information, if recognizing that a second payment card (e.g., A card) is a payment card having benefits at the current location, the controller 180 can control the display unit 151 to display a message 900 for checking whether to display a second indicator corresponding to the second payment card instead of the first indicator.

For example, if recognizing that a current location is the specific place L1 based on the location information and that a current timing is before Sep. 10, 2015, the controller 180 can control the display unit 151 to display the message 900 for checking whether to change an indicator, which is displayed first when an indicator corresponding to each of a plurality of the payment cards is displayed, into the A card.

In the message 900, the substance for checking whether to change a default card may be contained. Here, the default card means a payment card corresponding to an indicator displayed first when an indicator corresponding to each of a plurality of the payment cards is displayed.

If detecting a first command (e.g., command for selecting a first region 901 included in the message 900 shown in FIG. 13 (a)) through the message 900, the controller 180 can control the display unit 151 to first display a second indicator 1010 instead of the first indicator 1020 when an indicator corresponding to each of a plurality of the payment cards is displayed.

Particularly, referring to FIG. 13 (b), if detecting the first command for displaying the second indicator instead of the first indicator through the first message and recognizing that the current location of the mobile terminal 100 is the specific place L1 based on the location information, the controller 180 can control the display unit 151 to display the second indicator 1010 when an indicator corresponding to each of a plurality of the payment cards is displayed.

Yet, referring to FIG. 13 (c), if recognizing that the current location is not the specific place L1 based on the location information despite detecting the first command for displaying the second indicator instead of the first indicator through the first message 900, the controller 180 can control the display unit 151 to display the first indicator 1020 instead of the second indicator 1010 when an indicator corresponding to each of a plurality of the payment cards is displayed.

According to one embodiment of the present invention, if a payment is made through the second payment card corresponding to the second indicator 1010, a user can set the second indicator 1010 to be displayed despite that the current location of the mobile terminal 100 is recognized as a place other than the specific place L1.

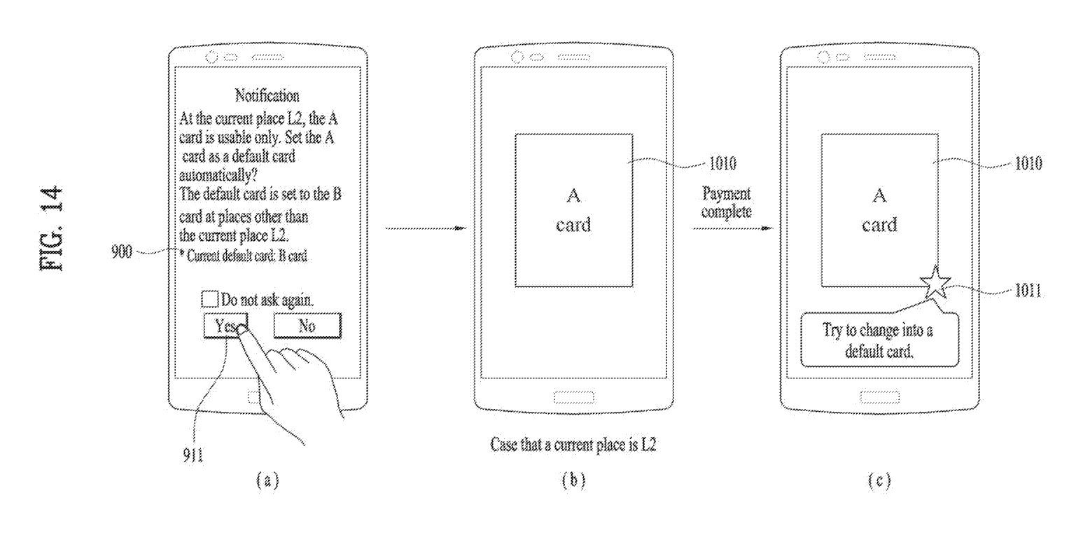

FIG. 14 is a diagram to describe another example of a method of changing an indicator corresponding to a payment card displayed first in response to a current location in a mobile terminal according to one embodiment of the present invention. Regarding FIG. 14, the substance redundant with the foregoing description with reference to FIGS. 5 to 13 will not be described but the following description shall be made centering on differences.

According to one embodiment of the present invention, the memory 170 can store identification information for identifying each of a plurality of payment cards and pattern information on a use pattern of each of a plurality of the payment cards. The controller 180 can control the wireless communication unit 110 to receive benefit information corresponding to card benefits of each of a plurality of the payment cards from an external server. The controller 180 can control the location information module 135 obtaining location information on a current location of the mobile terminal 100. When an indicator corresponding to each of a plurality of the payment cards is displayed, the controller 180 can control the display unit 151 to first display a first indicator corresponding to a first payment card. Based on at least one of the identification information, the pattern information, the benefit information and the location information, the controller 180 can recognize rank information corresponding to an output priority of each of a plurality of the payment cards. Here, the first payment card may include a payment card selected by a user so as to be displayed first when an indicator corresponding to each of a plurality of the payment cards is displayed.

Meanwhile, referring to FIG. 14 (a), if recognizing that it is possible to make a payment by a second payment card only at a first place corresponding to a current location of the mobile terminal 100, the controller 180 can control the display unit 151 to display a message 900 for checking whether to display a second indicator corresponding to the second payment card instead of the first indicator when an indicator corresponding to each of a plurality of the payment cards is displayed at the first place.

For example, if recognizing that it is possible to make a payment by an A payment card only at a first place L2 and that a current location is the first place L2 based on the location information, the controller 180 can control the display unit 151 to display a message 910 for checking whether to change an indicator, which is displayed first when an indicator corresponding to each of a plurality of the payment cards is displayed, into an indicator corresponding to the A card.

In the message 910, the substance for checking whether to change a default card may be contained. And, the default card means a payment card corresponding to an indicator displayed first when an indicator corresponding to each of a plurality of the payment cards is displayed.

Yet, the present invention is non-limited by the above description. If recognizing that the current location of the mobile terminal 100 is the first place L2, the controller 180 may control the display unit 151 to display the second indicator first without displaying the message 910.

Referring to FIG. 14 (b), if detecting a first command (e.g., command for selecting a first region 911 included in the message 910 shown in FIG. 14 (a)) through the message 910, the controller 180 can control the display unit 151 to first display a second indicator 1010 instead of the first indicator when an indicator corresponding to each of a plurality of the payment cards is displayed at the first place L2.

Meanwhile, referring to FIG. 14 (c), if a payment is made by the second payment card, the controller 180 can control the display unit 151 to display a specific indicator 1011 for setting the second payment card to be first displayed at places other than the first place L2. Hence, a user selects the specific indicator 1011, thereby setting the second payment card to be first displayed at places other than the first place L2.

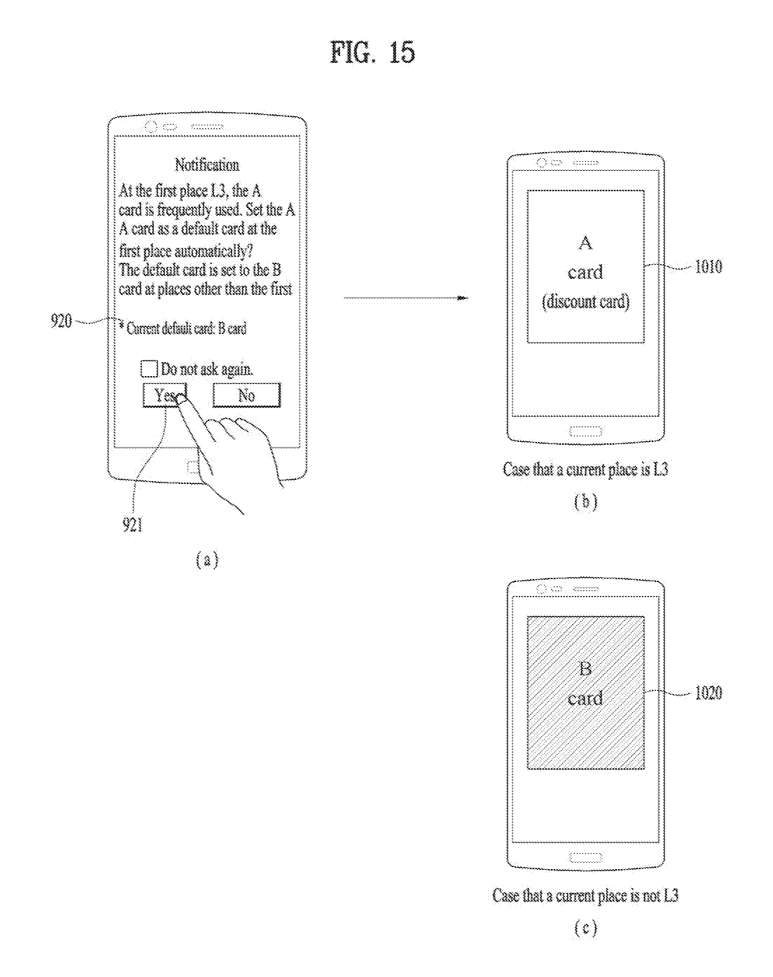

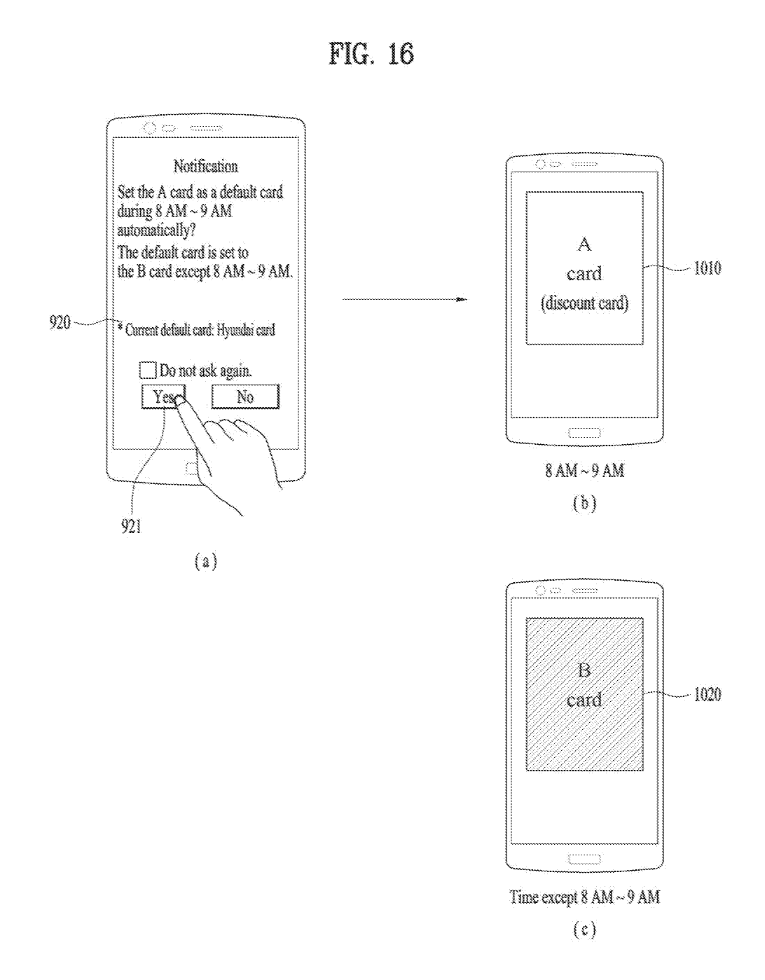

According to one embodiment of the present invention, the controller 180 can change an indicator corresponding to a payment card displayed first according to a use pattern of a plurality of payment cards stored in the memory 170. This is described in detail with reference to FIG. 15 and FIG. 16.

FIG. 15 is a diagram to describe one example of a method of changing an indicator corresponding to a payment card displayed first in response to a use pattern of a plurality of payment cards in a mobile terminal according to one embodiment of the present invention. Regarding FIG. 15, the substance redundant with the foregoing description with reference to FIGS. 5 to 14 will not be described but the following description shall be made centering on differences.

According to one embodiment of the present invention, the memory 170 can store identification information for identifying each of a plurality of payment cards and pattern information on a use pattern of each of a plurality of the payment cards. The controller 180 can control the wireless communication unit 110 to receive benefit information corresponding to card benefits of each of a plurality of the payment cards from an external server. The controller 180 can control the location information module 135 obtaining location information on a current location of the mobile terminal 100. When an indicator corresponding to each of a plurality of the payment cards is displayed, the controller 180 can control the display unit 151 to first display a first indicator corresponding to a first payment card. Based on at least one of the identification information, the pattern information, the benefit information and the location information, the controller 180 can recognize rank information corresponding to an output priority of each of a plurality of the payment cards. Based on the rank information, if recognizing that a payment card having a highest output priority among a plurality of the payment cards is a second payment card, the controller 180 can control the display unit 151 to display a first message for checking whether to display a second indicator corresponding to the second payment card instead of the first indicator. Here, the first payment card may include a payment card selected by a user so as to be displayed first when an indicator corresponding to each of a plurality of the payment cards is displayed.

The controller 180 can change an indicator, which is displayed when an indicator corresponding to each of a plurality of the payment cards is displayed, according to a use pattern of a plurality of the payment cards.

Particularly, referring to FIG. 15 (a), based on the pattern information, the controller 180 can recognize that a specific card (e.g., A card) has been used frequently at a specific place (e.g., first place L3). Based on the location information, if recognizing that a current location of the mobile terminal 100 is the first place L3, the controller 180 can recognize that the A card has a highest output priority higher than that of the first payment card. If recognizing that the A card is the payment card having the highest output priority, the controller 180 can control the display unit 151 to display a message 920 for checking whether to display a second indicator corresponding to the A card instead of the first indicator at the first place L3.

In the message 920, the substance for checking whether to change a default card may be contained. And, the default card means a payment card corresponding to an indicator displayed first when an indicator corresponding to each of a plurality of the payment cards is displayed.

Referring to FIG. 15 (b), if detecting a first command (e.g., command for selecting a first region 921 included in the message 920 shown in FIG. 15 (a)) through the message 920, the controller 180 can control the display unit 151 to first display a second indicator 1010 instead of the first indicator when an indicator corresponding to each of a plurality of the payment cards is displayed at the first place L3.

Yet, referring to FIG. 15 (c), although detecting the first command for displaying the second indicator instead of the first indicator through the message 920, if recognizing that a current location of the mobile terminal 100 is not the first place L3 based on the location information, the controller 180 can control the display unit 151 to display the first indicator 1020 instead of the second indicator 1010 when an indicator corresponding to each of a plurality of the payment cards is displayed.

Yet, the present invention is non-limited by the above description. If recognizing that the current location of the mobile terminal 100 is the first place L3, the controller 180 may control the display unit 151 to first display the second indicator 1010 without displaying the message 920.

FIG. 16 is a diagram to describe one example of a method of changing an indicator corresponding to a payment card displayed first in response to a use pattern of a plurality of payment cards in a mobile terminal according to one embodiment of the present invention. Regarding FIG. 16, the substance redundant with the foregoing description with reference to FIGS. 5 to 15 will not be described but the following description shall be made centering on differences.

According to one embodiment of the present invention, the memory 170 can store identification information for identifying each of a plurality of payment cards and pattern information on a use pattern of each of a plurality of the payment cards. The controller 180 can control the wireless communication unit 110 to receive benefit information corresponding to card benefits of each of a plurality of the payment cards from an external server. The controller 180 can control the location information module 135 obtaining location information on a current location of the mobile terminal 100. When an indicator corresponding to each of a plurality of the payment cards is displayed, the controller 180 can control the display unit 151 to first display a first indicator corresponding to a first payment card. Based on at least one of the identification information, the pattern information, the benefit information and the location information, the controller 180 can recognize rank information corresponding to an output priority of each of a plurality of the payment cards. Based on the rank information, if recognizing that a payment card having a highest output priority among a plurality of the payment cards is a second payment card, the controller 180 can control the display unit 151 to display a first message for checking whether to display a second indicator corresponding to the second payment card instead of the first indicator. Here, the first payment card may include a payment card selected by a user so as to be displayed first when an indicator corresponding to each of a plurality of the payment cards is displayed.

The controller 180 can change an indicator, which is displayed when an indicator corresponding to each of a plurality of the payment cards is displayed, according to a use pattern of a plurality of the payment cards.

Particularly, referring to FIG. 16 (a), based on the pattern information, the controller 180 can recognize that a specific card (e.g., A card) has been used frequently during a specific time (e.g., from 8 AM until 9 AM). If recognizing that a current time corresponds to the specific time, the controller 180 can recognize that the A card has a highest output priority higher than that of the first payment card. If recognizing that the A card is the payment card having the highest output priority, the controller 180 can control the display unit 151 to display a message 930 for checking whether to display a second indicator corresponding to the A card instead of the first indicator during the specific time.

In the message 930, the substance for checking whether to change a default card may be contained. And, the default card means a payment card corresponding to an indicator displayed first when an indicator corresponding to each of a plurality of the payment cards is displayed.

Referring to FIG. 16 (b), if detecting a first command (e.g., command for selecting a first region 931 included in the message 930 shown in FIG. 16 (a)) through the message 930, the controller 180 can control the display unit 151 to first display a second indicator 1010 instead of the first indicator when an indicator corresponding to each of a plurality of the payment cards is displayed during the specific time (e.g., from 8 AM until 9 AM).

Yet, referring to FIG. 16 (c), although detecting the first command for displaying the second indicator instead of the first indicator through the message 930, if a current time fails to correspond to the specific time (e.g., from 8 AM until 9 AM), the controller 180 can control the display unit 151 to display the first indicator 1020 instead of the second indicator 1010 when an indicator corresponding to each of a plurality of the payment cards is displayed.

Yet, the present invention is non-limited by the above description. If a current time corresponds to the specific time (e.g., from 8 AM until 9 AM), the controller 180 may control the display unit 151 to first display the second indicator 1010 without displaying the message 920.

Meanwhile, according to one embodiment of the present invention, based on the pattern information, if a current time and the current location correspond to a specific use pattern, the controller 180 can recognize a payment card having the specific use pattern as the second payment card. Here, the specific use pattern may include a user pattern contained in the pattern information. When an indicator corresponding to each of a plurality of the payment cards is displayed, if the current time and the current location correspond to the specific use pattern, the controller 180 can control the display unit 151 to first display the second indicator instead of the first indicator. If the current time and the current location fail to correspond to the specific use pattern, the controller 180 can control the display unit 151 to first display the first indicator when an indicator corresponding to each of a plurality of the payment cards is displayed.

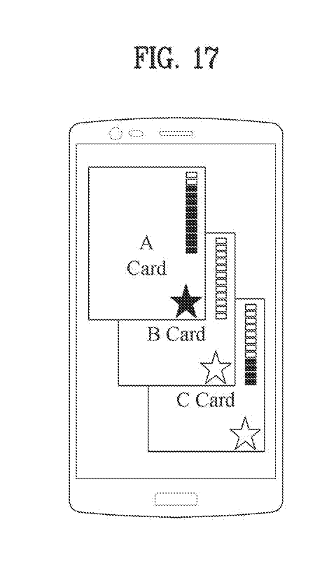

Meanwhile, according to one embodiment of the present invention, the controller 180 can control the display unit 151 to display information on a use limit of each of a plurality of payment cards and information on a use amount of each of a plurality of the payment cards. This is described in detail with reference to FIG. 17.

FIG. 17 is a diagram to describe one example of a method of displaying information on a use limit of each of a plurality of payment cards and information on a use amount of each of a plurality of the payment cards in a mobile terminal according to one embodiment of the present invention. Regarding FIG. 17, the substance redundant with the foregoing description with reference to FIGS. 5 to 16 will not be described but the following description shall be made centering on differences.

According to one embodiment of the present invention, the memory 170 can store identification information for identifying each of a plurality of payment cards. The controller 180 can control the wireless communication unit 115 to receive information on a use limit of each of a plurality of the payment cards and information on a use amount of each of a plurality of the payment cards from an external server (e.g., a card company server).

Referring to FIG. 17, when an indicator corresponding to each of a plurality of the payment cards is displayed, the controller 180 can control the display unit 151 to display information on a use limit of each of a plurality of the payment cards and information on a use amount of each of a plurality of the payment cards.

Meanwhile, according to an embodiment, the controller 180 can display a minimum payment amount or a use limit within an indicator corresponding to each of a plurality of the payment cards. Here, the minimum payment amount may include a minimum payment amount that should be used in order to be provided with a service or benefit provided by each of the payment cards. For example, when a 5% discount is available only if 300,000 WON or more is paid by the A card on a previous month, the minimum payment amount of the A card can be 300,000 WON.

Meanwhile, according to an embodiment, the controller 180 can control the display unit 151 to display payment cards, which have sufficient limits or fail to meet the minimum payment amount, in a manner of sorting out such payment cards in response to a specific command.

According to the present embodiment, since a user recognizes a use limit of each of a plurality of payment cards, the user can be advantageously guided to evenly use a plurality of the payment cards.

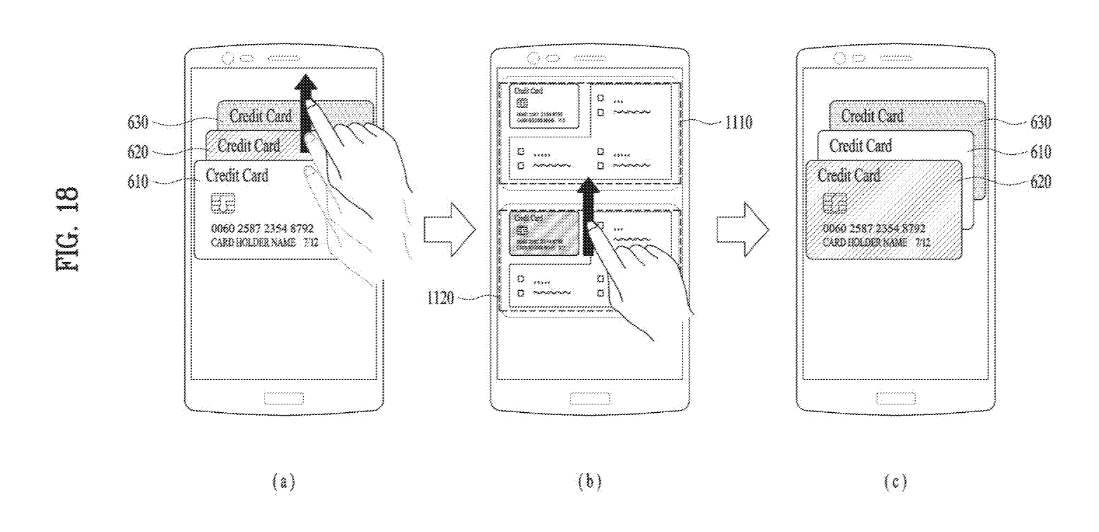

FIG. 18 is a diagram to describe another example of a method of changing an indicator of a payment card displayed first in a mobile terminal according to one embodiment of the present invention. Regarding FIG. 18, the substance redundant with the foregoing description with reference to FIGS. 5 to 17 will not be described but the following description shall be made centering on differences.

According to one embodiment of the present invention, identification information for identifying each of a plurality of payment cards can be stored in the memory 170. The controller can control the wireless communication unit 110 to receive benefit information corresponding to card benefits of each of a plurality of the payment cards from an external server.

Referring to FIG. 18 (a), the controller 180 can control the display unit 151 to display indicators 610, 620 and 630 respectively corresponding to a plurality of the payment cards based on the identification information. In doing so, the controller 180 can control the display unit 151 to display a first indicator 610 corresponding to a first payment card above the indicators 620 and 630. Here, the first payment card may include a payment card selected by a user so as to be displayed first when an indicator corresponding to each of a plurality of the payment cards is displayed.

Referring to FIG. 18 (b), in response to a first command (e.g., a touch command of touching a prescribed point within a region having the second indicator 620 displayed thereon and then dragging in a top direction) for selecting a second indicator 620 corresponding to a second payment card in FIG. 18 (a), the controller 180 can control the display unit 151 to display benefit information of the first payment card and benefit information of the second payment card on a first region 1110 and a second region 110 based on the benefit information, respectively. Here, by displaying the benefit information of the first payment card on the first region 1110 as soon as displaying the benefit information of the second payment card on the second region 1120, the benefits of the payment cards can be compared with each other advantageously.

The benefit information of the first payment card and the benefit information of the second payment card may include information (e.g., a discount rate, an interest-free installment plan term, a saving rate, etc.) on major benefits of the first payment card and the second payment card, respectively.

Referring to FIG. 18 (c), in response to a second command (e.g., a touch command of touching a random point within the second region 1120 and then dragging in a specific direction (top/bottom/right/left)), the controller 180 can control the display unit 151 to display the second indicator 620, which corresponds to the second payment card, above other indicators 610 and 630.

Meanwhile, according to an embodiment, while the benefit information of the first payment card and the benefit information of the second payment card are displayed, in response to a third command (e.g., a touch command of touching a random point within the first region 1110 and then dragging in a specific direction (top/bottom/right/left)), the controller 180 can control the display unit 151 to display the first indicator 610, which corresponds to the first payment card, above other indicators 620 and 630 like FIG. 18 (a). Namely, the controller 180 can control the display unit 151 to display the indicators in the original states intactly in response to the third command.

According to the present embodiment, a user compares benefits of payment cards with each other at a glance, thereby being advantageously able to determine that an indicator corresponding to a prescribed payment card can be displayed on the top side when an indicator corresponding to each of a plurality of the payment cards is displayed.

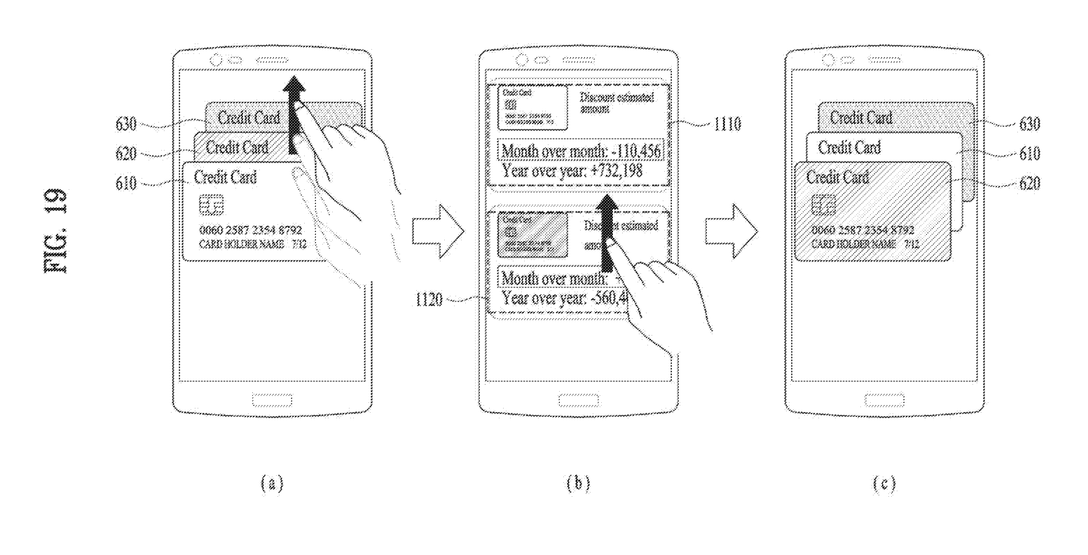

FIG. 19 is a diagram to describe another example of a method of changing an indicator of a payment card displayed first in a mobile terminal according to one embodiment of the present invention. Regarding FIG. 19, the substance redundant with the foregoing description with reference to FIGS. 5 to 18 will not be described but the following description shall be made centering on differences.

According to one embodiment of the present invention, identification information for identifying each of a plurality of payment cards can be stored in the memory 170. The controller can control the wireless communication unit 110 to receive benefit information corresponding to card benefits of each of a plurality of the payment cards from an external server.

Referring to FIG. 19 (a), the controller 180 can control the display unit 151 to display indicators 610, 620 and 630 respectively corresponding to a plurality of the payment cards based on the identification information. In doing so, the controller 180 can control the display unit 151 to display a first indicator 610 corresponding to a first payment card above the indicators 620 and 630. Here, the first payment card may include a payment card selected by a user so as to be displayed first when an indicator corresponding to each of a plurality of the payment cards is displayed.

Referring to FIG. 19 (b), in response to a first command (e.g., a touch command of touching a random prescribed point within a region having the second indicator 620 displayed thereon and then dragging in a top direction) for selecting a second indicator 620 corresponding to a second payment card in FIG. 19 (a), the controller 180 can control the display unit 151 to display discount amount information, which is estimated in case of using the first payment card based on the benefit information, and discount amount information, which is estimated in case of using the second payment card based on the benefit information, on a first region 1110 and a second region 1120, respectively.

In the memory 170, algorithm for recognizing discount amount information estimated in case of making payments by a plurality of the payment cards based on the benefit information may be stored in advance.

The discount amount information estimated in case of using the first payment card and the discount amount information estimated in case of using the second payment card may at least contain information on a discount estimated amount by being compared with a previous month in case of using the first payment card (or the second payment card) and information on a discount estimated amount by being compared with a previous year in case of using the first payment card (or the second payment card).

Referring to FIG. 19 (c), in response to a second command (e.g., a touch command of touching a random point within the second region 1120 and then dragging in a specific direction (top/bottom/right/left)), the controller 180 can control the display unit 151 to display the second indicator 620, which corresponds to the second payment card, above other indicators 610 and 630.

Meanwhile, according to an embodiment, while the benefit information of the first payment card and the benefit information of the second payment card are displayed, in response to a third command (e.g., a touch command of touching a random point within the first region 1110 and then dragging in a specific direction (top/bottom/right/left)), the controller 180 can control the display unit 151 to display the first indicator 610, which corresponds to the first payment card, above other indicators 620 and 630 like FIG. 19 (a). Namely, the controller 180 can control the display unit 151 to display the indicators in the original states intactly in response to the third command.

According to the present embodiment, a user compares discount amounts, which are estimated in case of using payment cards, with each other at a glance, thereby being advantageously able to determine which indicator corresponding to a prescribed payment card will be displayed on the top side in displaying indicators respectively corresponding to a plurality of the payment cards.

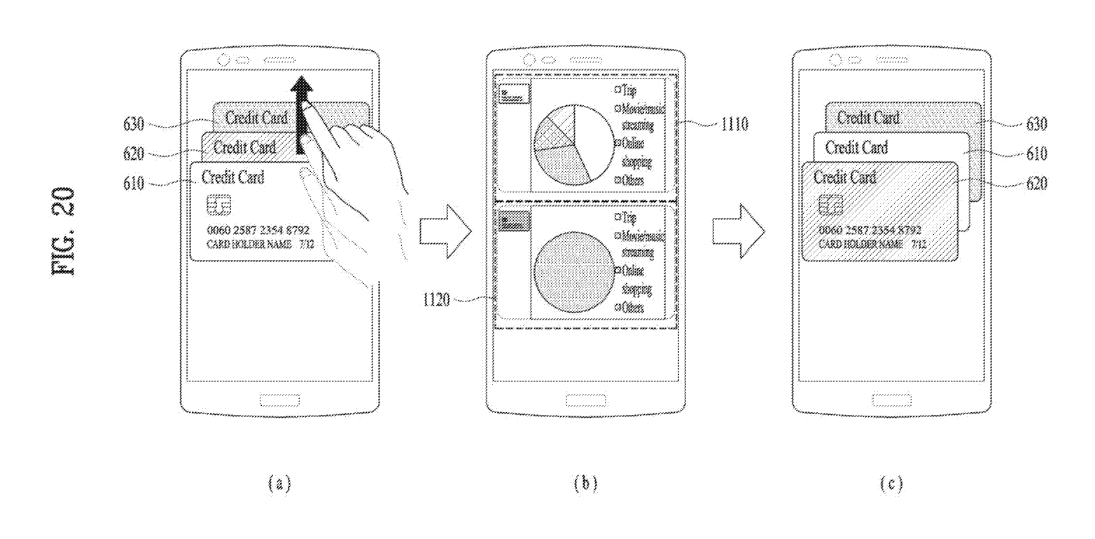

FIG. 20 is a diagram to describe another example of a method of changing an indicator of a payment card displayed first in a mobile terminal according to one embodiment of the present invention. Regarding FIG. 20, the substance redundant with the foregoing description with reference to FIGS. 5 to 19 will not be described but the following description shall be made centering on differences.

According to one embodiment of the present invention, identification information for identifying each of a plurality of payment cards can be stored in the memory 170. The controller 180 can save pattern information on a use pattern of each of a plurality of the payment cards to the memory 170.

Referring to FIG. 20 (a), the controller 180 can control the display unit 151 to display indicators 610, 620 and 630 respectively corresponding to a plurality of the payment cards based on the identification information. In doing so, the controller 180 can control the display unit 151 to display a first indicator 610 corresponding to a first payment card above the indicators 620 and 630. Here, the first payment card may include a payment card selected by a user so as to be displayed first when an indicator corresponding to each of a plurality of the payment cards is displayed.

Referring to FIG. 20 (b), in response to a first command (e.g., a touch command of touching a random prescribed point within a region having the second indicator 620 displayed thereon and then dragging in a top direction) for selecting a second indicator 620 corresponding to a second payment card in FIG. 20 (a), the controller 180 can control the display unit 151 to display information on a use history of the first payment card on a first region 1110 and also display information on a use history of the second payment card on a second region 1120, based on the pattern information and the benefit information.

The information on the use history of the first payment card and the information on the use history of the second payment card may include information indicating how many payments are made by a user in the respective fields (e.g., trip field, movie/music field, etc.) using the first payment card (or, the second payment card).

For example, the controller 180 can output the information on the use history of the first payment card and the information on the use history of the second payment card in form of circular charts.

Therefore, by checking the information on the use history of the first payment card and the information on the use history of the second payment card, the user can confirm how many payments are made by the user in the respective fields (e.g., trip field, movie/music field, etc.) using the first payment card (or, the second payment card) at a glance.

Meanwhile, if recognizing that the second payment card has been used most frequently on a specific application (e.g., trip related application) based on the pattern information, the controller 180 can control the display unit 151 to display an indicator corresponding to the second payment card in case of making a payment on the specific application.

Referring to FIG. 20 (c), in response to a second command (e.g., a touch command of touching a random point within the second region 1120 and then dragging in a specific direction (top/bottom/right/left)), the controller 180 can control the display unit 151 to display the second indicator 620, which corresponds to the second payment card, above other indicators 610 and 630.

Meanwhile, according to an embodiment, while the benefit information of the first payment card and the benefit information of the second payment card are displayed, in response to a third command (e.g., a touch command of touching a random point within the first region 1110 and then dragging in a specific direction (top/bottom/right/left)), the controller 180 can control the display unit 151 to display the first indicator 610, which corresponds to the first payment card, above other indicators 620 and 630 like FIG. 20 (a). Namely, the controller 180 can control the display unit 151 to display the indicators in the original states intactly in response to the third command.

According to the present embodiment, when an indicator corresponding to each of a plurality of the payment cards is displayed, a user can advantageously determine that an indicator corresponding to a prescribed payment card will be displayed on the top side in a manner of comparing and checking that each of a plurality of the payment cards is frequently used in a prescribed field at a glance.

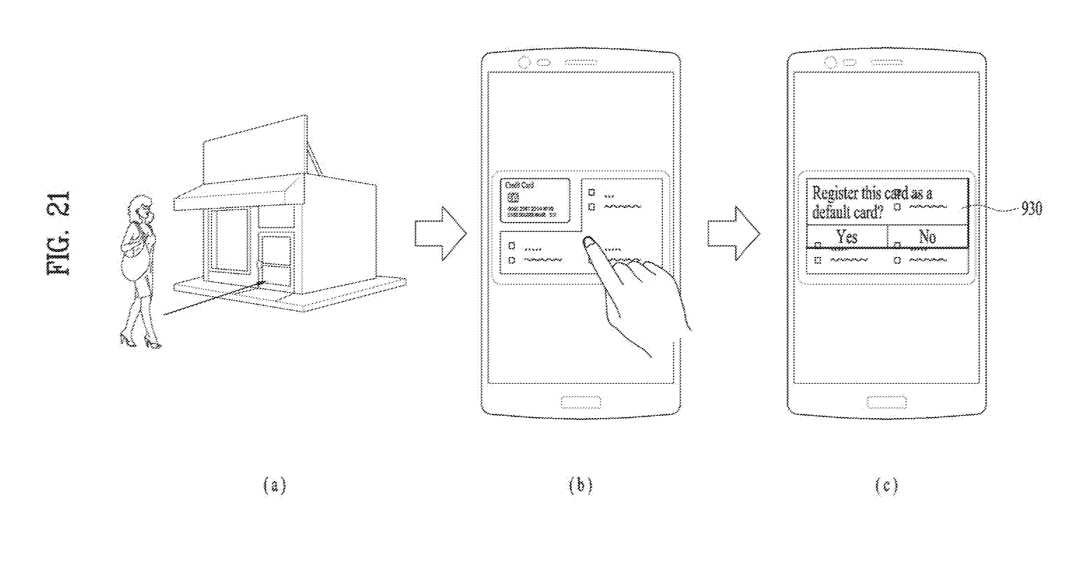

FIG. 21 is a diagram to describe one example of a method of displaying an indicator corresponding to a specific payment card in response to a current location in a mobile terminal according to one embodiment of the present invention. Regarding FIG. 21, the substance redundant with the foregoing description with reference to FIGS. 5 to 20 will not be described but the following description shall be made centering on differences.

According to one embodiment of the present invention, the controller 180 can save identification information for identifying each of a plurality of payment cards to the memory 170. The controller can control the wireless communication unit 110 to receive benefit information corresponding to card benefits of each of a plurality of the payment cards from an external server. The controller 180 can control the location information module 115 to obtain location information on a current location of the mobile terminal 100.

Referring to FIG. 21 (a), based on the location information and the benefit information, the controller 180 can recognize that a user of the mobile terminal 100 passes by or enters a shop having card benefits related to a specific card.

Referring to FIG. 21 (b), if recognizing that the user of the mobile terminal 100 passes by or enters the shop having the card benefits related to the specific card, the controller 180 can control the display unit 151 to display information on benefits of the specific card. Here, the information on the benefits of the specific card may include information on benefits (e.g., information on additional discount, etc.) given if the specific card is registered as a payment card displayed first when an indicator corresponding to each of a plurality of the payment cards is displayed.

Referring to FIG. 21 (c), in response to a touch command of touching a prescribed point within the region in which the information on the benefits of the specific card is displayed in FIG. 21 (b), the controller 180 can control the display unit 151 to display a message 930 for checking whether to first display an indicator corresponding to the specific card when an indicator corresponding to each of a plurality of the payment cards is displayed.

In the message 930, the substance for checking whether to change a default card may be contained. And, the default card means a payment card corresponding to an indicator displayed first when an indicator corresponding to each of a plurality of the payment cards is displayed.

In case of detecting a first command for first displaying the indicator corresponding to the specific card through the first message, the controller 180 can control the display unit 151 to first display the indicator corresponding to the specific card when an indicator corresponding to each of a plurality of the payment cards is displayed.

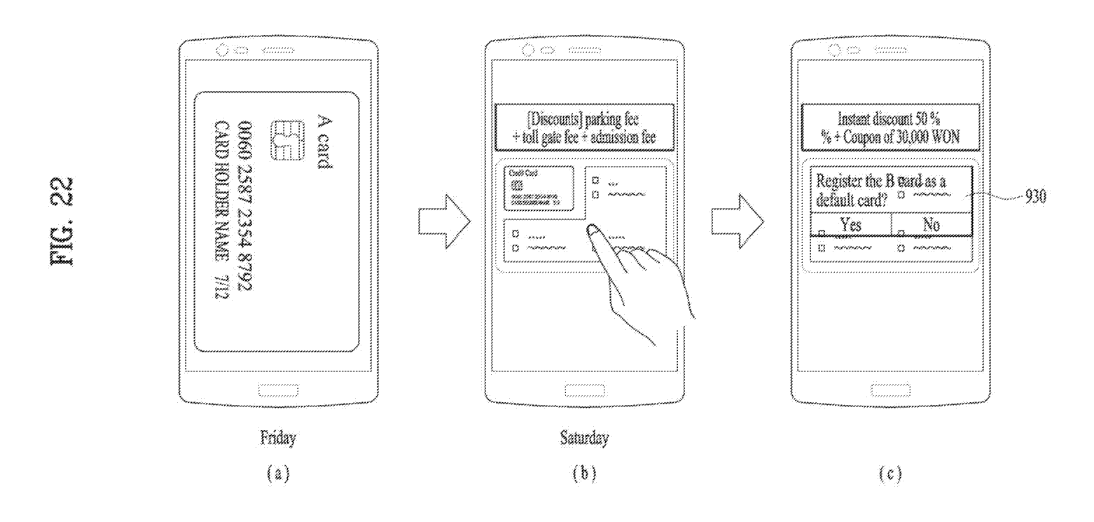

Meanwhile, according to one embodiment of the present invention, the controller 180 can display an indicator corresponding to a payment card having benefits during a specific period. This is described in detail with reference to FIG. 22.

FIG. 22 is a diagram to describe one example of a method of displaying an indicator corresponding to a payment card having benefits during a specific period in a mobile terminal according to one embodiment of the present invention. Regarding FIG. 22, the substance redundant with the foregoing description with reference to FIGS. 5 to 21 will not be described but the following description shall be made centering on differences.

According to one embodiment of the present invention, the memory 170 can store identification information for identifying each of a plurality of payment cards. The controller 180 can control the wireless communication unit 110 to receive benefit information corresponding to card benefits of each of a plurality of the payment cards from an external server. The benefit information may include information on a payment card having benefits during a specific period.

The controller 180 can control the display unit 151 to display an indicator corresponding to each of a plurality of the payment cards based on the identification information. The controller 180 can control the display unit 151 to first display a first indicator corresponding to a first payment card when an indicator corresponding to each of a plurality of the payment cards is displayed. Here, the first payment card may include a payment card selected by a user so as to be displayed first when an indicator corresponding to each of a plurality of the payment cards is displayed. Yet, if recognizing that a third payment card is a payment card having benefits currently based on the information on the payment card having the benefits during the specific period, the controller 180 can control the display unit 151 to display a message for checking whether to display a third indicator corresponding to the third payment card instead of the first indicator.

For example, the controller 180 can control the wireless communication unit 110 to receive information, which indicates that the B card has discount benefits of a parking fee, toll gate fee and an admission fee during 1 day (Saturday), from the external server. Referring to FIG. 22 (a), based on the benefit information, the controller 180 can control the display unit 151 to display a first indicator corresponding to the first payment card before a specific period in which the benefits exist. Referring to FIG. 22 (b), if a current timing corresponds to Saturday, which is the specific period, based on the benefit information, the controller 180 can control the display unit 151 to display benefit information of the third payment card. Referring to FIG. 22 (c), in response to a touch command for selecting the displayed benefit information, the controller 180 can control the display unit 151 to display a message 930 for checking whether to display a third indicator corresponding to the third payment card instead of the first indicator. In the message 930, the substance for checking whether to change a default card may be contained. And, the default card means a payment card corresponding to an indicator displayed first when an indicator corresponding to each of a plurality of the payment cards is displayed.

Meanwhile, according to an embodiment, if detecting a command for displaying the third indicator instead of the first indicator through the message 930, the controller 180 can control the display unit 151 to first display the third indicator instead of the first indicator when an indicator corresponding to each of a plurality of the payment cards is displayed.

Meanwhile, according to one embodiment of the present invention, a schedule may be stored in the memory 170 in advance. The controller 180 can recognize a fourth payment card, which has card benefits during a period having the schedule exist therein based on the schedule stored in the memory 170, based on the second information. And, the controller 180 can control the display unit 151 to output a message for checking whether to change the default card into the fourth payment card during the schedule existing period.

According to the present embodiment, a card company can promote its card and induce a user to change the default card into the company card advantageously.

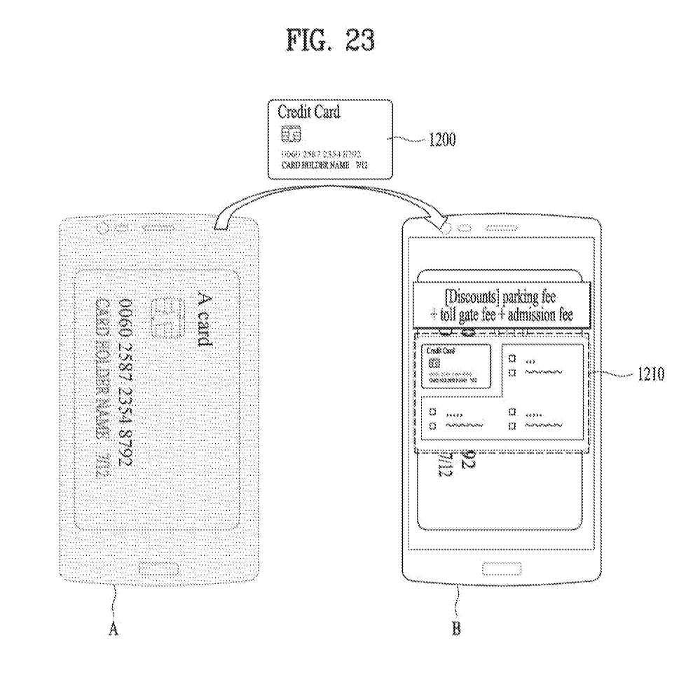

Meanwhile, according to one embodiment of the present invention, the controller 180 sends a specific payment card to an external mobile terminal, thereby controlling the specific payment card to be usable in the external mobile terminal. This is described in detail with reference to FIG. 23.

FIG. 23 is a diagram to describe one example of a method of sending a specific payment card to an external module terminal in a mobile terminal according to one embodiment of the present invention. Regarding FIG. 23, the substance redundant with the foregoing description with reference to FIGS. 5 to 22 will not be described but the following description shall be made centering on differences.

According to one embodiment of the present invention, the controller 180 of a first mobile terminal A can save identification information for identifying each of a plurality of payment cards to the memory 170.

Referring to FIG. 23, the controller 180 can control the wireless communication unit 110 to connect communication with a second mobile terminal B. Here, a method of connecting the communication between the first mobile terminal A and the second mobile terminal B may include short-range communication, by which the present invention is non-limited. The second mobile terminal may include a watch or glass type mobile terminal, by which the present invention is non-limited.

In response to a first command, the controller 180 of the first mobile terminal A can control the wireless communication unit 110 to send the second mobile terminal B identification information for identifying a specific payment card 1200.

For example, the sent identification information may contain information on a card number of the specific payment card 1200, information on a valid period of the specific payment card 1200, and the like.

Meanwhile, according to an embodiment, when the controller 180 of the first mobile terminal A sends the specific payment card 1200 to the second mobile terminal B, it may send information on a period usable in the second mobile terminal B as well. Therefore, in the second mobile terminal B, the specific payment card 1200 is usable only for a period contained in the information on the period.

Meanwhile, in case of receiving identification information for identifying the specific payment card 1200, the controller 180 of the second mobile terminal B can control the display unit 151 to display an indicator corresponding to the specific payment card 1200.

Moreover, the controller 180 can control the display unit 151 to display information on card benefits of the specific payment card 1200 using the received identification information.

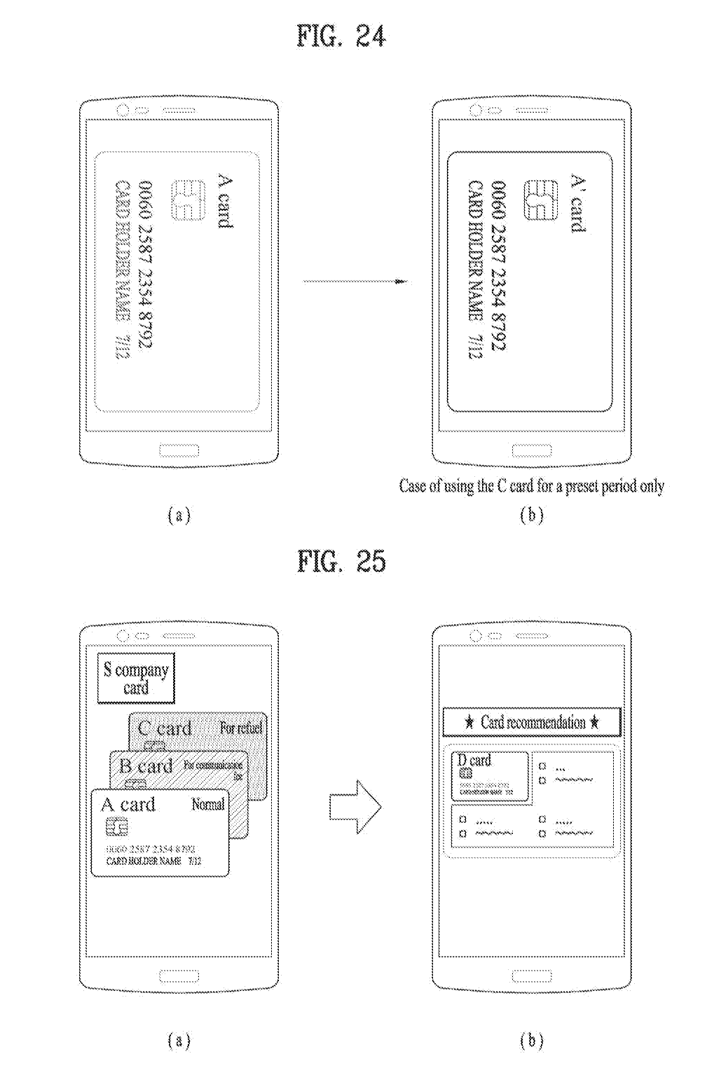

Meanwhile, according to one embodiment of the present invention, if a payment card, which if displayed first when an indicator corresponding to each of a plurality of the payment cards is displayed, is maintained as a specific payment card during a preset period, a card level of the specific payment card may be upgraded. This is described in detail with reference to FIG. 24.

FIG. 24 is a diagram to describe one example of a method of upgrading a card level of a specific payment card in a mobile terminal according to one embodiment of the present invention. Regarding FIG. 24, the substance redundant with the foregoing description with reference to FIGS. 5 to 23 will not be described but the following description shall be made centering on differences.

According to one embodiment of the present invention, the memory 170 can store identification information for identifying each of a plurality of payment cards.

Referring to FIG. 24 (a), when the controller 180 controls the display unit 151 to display an indicator corresponding to each of a plurality of the payment cards based on the identification information, the controller 180 can control the display unit 151 to first display a first indicator corresponding to a first payment card. Here, the first payment card may include a payment card selected by a user so as to be displayed first when an indicator corresponding to each of a plurality of the payment cards is displayed.

Meanwhile, if a period, for which the first indicator is set as an indicator displayed first in case of displaying an indicator corresponding to each of a plurality of the payment cards, passes a preset period, the controller 180 can upgrade a card level of the first payment card.

Particularly, the controller 180 can recognize the period for the first indicator to be set as the indicator displayed first. And, if the recognized period passes a preset period (e.g., 1 month), the controller 180 can send the recognized period to an external server. After the external server has confirmed the recognized period, if a preset condition is met, the external server can upgrade a card level of the first payment card and send the mobile terminal 100 information indicating that the card level of the first payment card is upgraded.

Referring to FIG. 24 (b), if receiving the information indicating that the first payment card is upgraded from the external server, the controller 180 can control the display unit 151 to display an indicator of the upgraded first payment card.

The upgraded first payment card may provide card benefits enhanced than those of the first payment card before the upgrade.

For one example, according to the upgraded first payment card, point saving can be performed additionally.

For another example, if a user makes a payment on a specific application using the upgraded first payment card, a discount rate of an amount of a payment made on the specific application may be higher than that of a case of making a payment on the specific application using the first payment card before the upgrade.

For further example, the number of applications giving benefits in case of making a payment using the upgraded first payment card may become greater than that of a case of making a payment using the first payment card before the upgrade.

Meanwhile, according to one embodiment of the present invention, a specific card can be recommended based on a payment card use pattern of a user. This is described in detail with reference to FIG. 25.

FIG. 25 is a diagram to describe another example of a method of upgrading a card level of a specific payment card in a mobile terminal according to one embodiment of the present invention. Regarding FIG. 25, the substance redundant with the foregoing description with reference to FIGS. 5 to 24 will not be described but the following description shall be made centering on differences.

According to one embodiment of the present invention, identification information for identifying each of a plurality of payment cards can be stored in the memory 170. The controller 180 may save pattern information on a use pattern of each of a plurality of the payment cards to the memory 170.

Referring to FIG. 25 (a), the controller 180 can control the display unit 151 to display an indicator corresponding to each of a plurality of the payment cards. Based on the pattern information, the controller 180 can control the display unit 151 to display information on a field, in which each of the payment cards is frequently used, on the indicator corresponding to each of a plurality of the payment cards.

For example, based on the pattern information, if recognizing that the A card is used normally and frequently, the controller 180 can control the display unit 151 to display a word ‘normal’ on an indicator corresponding to the A card. If recognizing that the B card is frequently used in paying a communication fee based on the pattern information, the controller 180 can control the display unit 151 to display words ‘for communication fee’ on an indicator corresponding to the B card. If recognizing that the C card is frequently used as a gas station, the controller 180 can control the display unit 151 to display words ‘for refuel’ on an indicator corresponding to the C card.

And, the controller 180 can control the wireless communication unit to send an external server information on a field frequently used by each of a plurality of the payment cards. For example, the controller 180 can control the wireless communication unit to send information indicating that the A card is used normally and frequently, information indicating that the B card is frequently used in paying a communication fee, and information indicating that the C card is frequently used for refuel to the external server.

The controller 180 can control the wireless communication unit 110 to receive information on a recommended card in response to the sent information on the field, in which each of a plurality of the payment cards is frequently used, from the external server.

Meanwhile, referring to FIG. 25 (b), the controller 180 can control the display unit 151 to display the information on the recommended card based on the received information on the recommended card.

According to the present embodiment, as an appropriately recommended card is provided based on a payment card use pattern of a user, each user can be encouraged to use various cards in aspect of a card company.

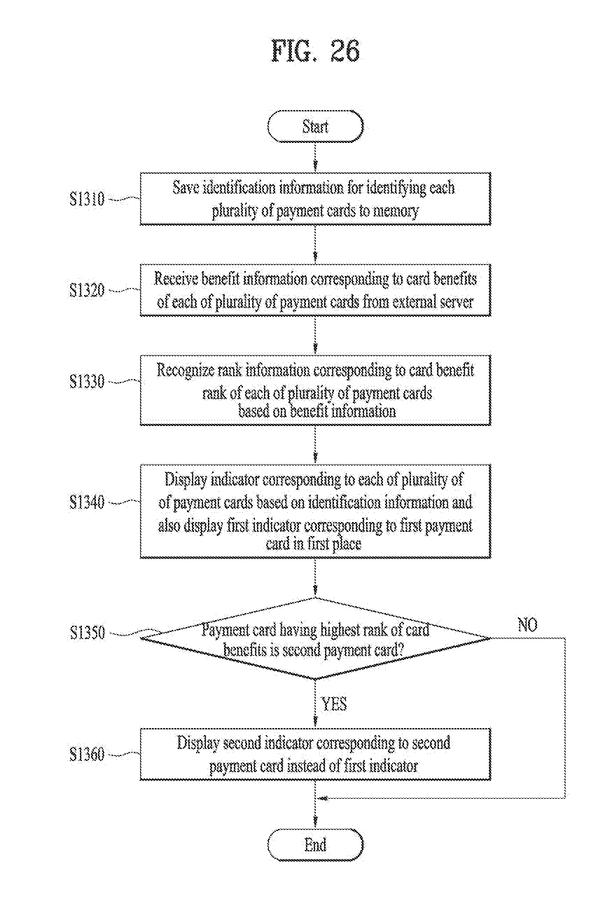

FIG. 26 is a diagram to describe one example of a method of displaying an indicator corresponding to a payment card stored in a memory in a mobile terminal according to one embodiment of the present invention. Regarding FIG. 26, the substance redundant with the foregoing description with reference to FIGS. 5 to 25 will not be described but the following description shall be made centering on differences.

According to one embodiment of the present invention, the controller 180 can save identification information for identifying each of a plurality of payment cards to the memory 170 [S1310].

The controller 180 can control the wireless communication unit 110 to receive benefit information corresponding to card benefits of each of a plurality of the payment cards from an external server [S1320]. Meanwhile, according to an embodiment, the benefit information may contain information on a payment card having benefits for a specific period.

The controller 180 can recognize rank information corresponding to a card benefit rank of each of a plurality of the payment cards based on the benefit information [S1330].

The controller 180 can control the display unit 151 to display an indicator corresponding to each of a plurality of the payment cards based on the identification information and also display a first indicator corresponding to a first payment card in the first place [S1340]. Here, the first payment card may include a payment card corresponding to an indicator selected by a user so as to be displayed first when an indicator corresponding to each of a plurality of the payment cards is displayed.

Based on the rank information, the controller 180 can recognize whether a payment card having a highest rank of card benefits is a second payment card instead of the first payment card [S1350].

If recognizing that the payment card having the highest rank of card benefits is the second payment card instead of the first payment card [S1350, Yes], the controller 180 can control the display unit 151 to display a second indicator corresponding to the second payment card instead of the first indicator [S1360].

Yet, according to an embodiment, if recognizing that the payment card having the highest card benefit rank among a plurality of the payment cards is the second payment card based on the rank information, the controller 180 may control the display unit 151 to display a first message for checking whether to display the second indicator instead of the first indicator. If detecting a first command for displaying the second indicator instead of the first indicator through the first message, the controller 180 can control the display unit 151 to first display the second indicator instead of the first indicator when an indicator corresponding to each of a plurality of the payment cards is displayed.

Yet, if recognizing that the payment card having the highest rank of card benefits is the first payment card [S1350, No], the controller 180 can control the display unit 151 to continue to display the first indicator.

Meanwhile, according to an embodiment, if recognizing that a third payment card is a payment card having benefits currently based on the information on the payment card having the benefits during the specific period contained in the benefit information, the controller 180 can control the display unit 151 to display a second message for checking whether to display a third indicator corresponding to the third payment card instead of the first indicator. If detecting a second command for displaying the third indicator instead of the first indicator through the second message, the controller 180 can control the display unit 151 to first display the third indicator instead of the first indicator when an indicator corresponding to each of a plurality of the payment cards is displayed.

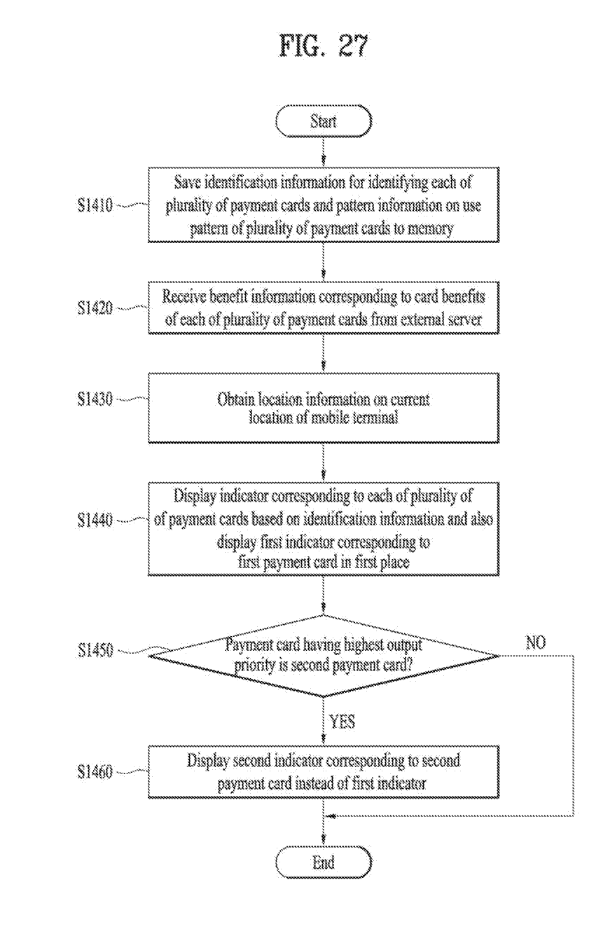

FIG. 27 is a diagram to describe one example of another method of displaying an indicator corresponding to a payment card stored in a memory in a mobile terminal according to one embodiment of the present invention. Regarding FIG. 27, the substance redundant with the foregoing description with reference to FIGS. 5 to 26 will not be described but the following description shall be made centering on differences.

According to one embodiment of the present invention, the controller 180 can save identification information for identifying each of a plurality of payment cards and pattern information on a use pattern of each of a plurality of the payment cards to the memory 170 [ S1410].

The controller 180 can control the wireless communication unit 110 to receive benefit information corresponding to card benefits of each of a plurality of the payment cards from an external server [S1420].

The controller 180 can control the location information module 115 to obtain location information on a current location of the mobile terminal [S1430].

The controller 180 can control the display unit 151 to display an indicator corresponding to each of a plurality of the payment cards based on the identification information and also display a first indicator corresponding to a first payment card in the first place [S1440]. Here, the first payment card may include a payment card corresponding to an indicator selected by a user so as to be displayed first when an indicator corresponding to each of a plurality of the payment cards is displayed.

Based on at least one of the identification information, the pattern information, the benefit information and the location information, the controller 180 can recognize information corresponding to an output priority of each of a plurality of the payment cards. And, the controller 180 can recognize whether a payment card having a highest output priority is a second payment card [S1450].

If recognizing that the payment card having the highest output priority among a plurality of the payment cards is the second payment card based on the information corresponding to the output priority, the controller 180 can control the display unit 151 to display a second indicator corresponding to the second payment card instead of the first indicator [ S1460].

Yet, according to an embodiment, if recognizing that the payment card having the highest output priority among a plurality of the payment cards is the second payment card based on the information corresponding to the output priority [S1450, Yes], the controller 180 may control the display unit 151 to display a first message for checking whether to display the second indicator instead of the first indicator. If detecting a first command for displaying the second indicator instead of the first indicator through the first message, the controller 180 can control the display unit 151 to first display the second indicator instead of the first indicator when an indicator corresponding to each of a plurality of the payment cards is displayed.

According to an embodiment, based on the benefit information and the location information, the controller 180 may recognize the payment card having card benefits at a current location and time as the second payment card.

Yet, if recognizing that the payment card having the highest output priority is the first payment card [S1450, No], the controller 180 can control the display unit 151 to continue to display the first indicator.

Meanwhile, according to an embodiment, if at least one of a current time and a current location corresponds to a specific use pattern based on the pattern information, the controller 180 may recognize a payment card having the specific use pattern as the second payment card. In case of detecting a first command for displaying the second indicator instead of the first indicator through the first message, the controller 180 can control the display unit 151 to first display the second indicator instead of the first indicator if at least one of the current time and the current location corresponds to the specific use pattern when an indicator corresponding to each of a plurality of the payment cards is displayed. Yet, even if detecting the first command for displaying the second indicator instead of the first indicator through the first message, if at least one of the current time and the current location fails to correspond to the specific use pattern when an indicator corresponding to each of a plurality of the payment cards is displayed, the controller 180 can control the display unit 151 to display the first indicator in the first place.

According to at least one of the aforementioned embodiments of the present invention, a payment card displayed first is changed into a payment card most profitable to a user among payment cards of various types, thereby providing a user with convenience advantageously. And, it is advantageous in that a credit card company can easily induce users to use cards of the credit card company.

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller 180 of the terminal. The foregoing embodiments are merely exemplary and are not to be considered as limiting the present disclosure. The present teachings can be readily applied to other types of methods and apparatuses. Thus, it is intended that the present invention covers the modifications and variations of this invention that come within the scope of the appended claims and their equivalents.

### MODE FOR INVENTION

Various embodiments are described in ‘BEST MODE FOR INVENTION’ for implementing the present invention.

### INDUSTRIAL APPLICABILITY

The present invention is used in the fields related to a mobile terminal configured to receive a photographed image from an external camera.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal, comprising:
a memory configured to store first information for identifying each of a plurality of payment cards and a second information on a use pattern of each of a plurality of the payment cards;
a wireless communication unit configured to receive a third information corresponding to card benefits of each of a plurality of the payment cards from an external server;
a location information module configured to obtain a fourth information on a current location of the mobile terminal;
a display unit configured to display an indicator corresponding to each of a plurality of the payment cards based on the first information; and
a controller configured to control the display unit to first display a first indicator corresponding to a first payment card when the indicator corresponding to each of a plurality of the payment cards is displayed,
wherein the controller is further configured to:
recognize a fifth information corresponding to an output priority of each of a plurality of the payment cards based on at least one of the first to fourth information, and
wherein when recognizing that a payment card having a highest output priority among a plurality of the payment cards is a second payment card based on the fifth information, control the display unit to display a first message for checking whether to display a second indicator corresponding to the second payment card instead of the first indicator.

2. The mobile terminal of claim 1, wherein the first payment card comprises a payment card selected by a user so as to be displayed first when the indicator corresponding to each of a plurality of the payment cards is displayed.

3. The mobile terminal of claim 1, wherein if detecting a first command for displaying the second indicator instead of the first indicator through the first message, the controller is further configured to control the display unit to display the second indicator first instead of the first indicator when the indicator corresponding to each of a plurality of the payment cards is displayed.

4. The mobile terminal of claim 1, wherein the controller is further configured to recognize a payment card having the card benefits on a current time and at the current location as the second payment card based on the third information and the fourth information.

5. The mobile terminal of claim 1, wherein if at least one of a current time and the current location corresponds to a specific use pattern based on the second information, the controller is further configured to recognize a payment card having the specific use pattern as the second payment card.

6. The mobile terminal of claim 5, wherein in case of detecting a first command for displaying the second indicator instead of the first indicator through the first message, if at least one of the current time and the current location corresponds to the specific use pattern when the indicator corresponding to each of a plurality of the payment cards is displayed, the controller is further configured to control the display unit to first display the second indicator instead of the first indicator.

7. The mobile terminal of claim 6, wherein if at least one of the current time and the current location fails to correspond to the specific use pattern, the controller is further configured to control the display unit to first display the first indicator when the indicator corresponding to each of a plurality of the payment cards is displayed.

8. A method of controlling a mobile terminal, comprising:
saving a first information for identifying each of a plurality of payment cards and a second information on a use pattern of each of a plurality of the payment cards to a memory;
receiving a third information corresponding to card benefits of each of a plurality of the payment cards from an external server;
obtaining a fourth information on a current location of the mobile terminal;
recognizing a fifth information corresponding to an output priority of each of a plurality of the payment cards based on at least one of the first to fourth information;
displaying an indicator corresponding to each of a plurality of the payment cards based on the first information in a manner of first displaying a first indicator corresponding to a first payment card; and
if recognizing that a payment card having a highest output priority among a plurality of the payment cards is a second payment card based on the fifth information, displaying a first message for checking whether to display a second indicator corresponding to the second payment card instead of the first indicator.

9. The method of claim 8, wherein the first payment card comprises a payment card selected by a user so as to be displayed first when the indicator corresponding to each of a plurality of the payment cards is displayed.

10. The method of claim 8, further comprising, if detecting a first command for displaying the second indicator instead of the first indicator through the first message, displaying the second indicator first instead of the first indicator when the indicator corresponding to each of a plurality of the payment cards is displayed.

11. The method of claim 8, further comprising recognizing a payment card having the card benefits on a current time and at the current location as the second payment card based on the third information and the fourth information.

12. The method of claim 8, further comprising, if at least one of a current time and the current location corresponds to a specific use pattern based on the second information, recognizing a payment card having the specific use pattern as the second payment card.

13. The method of claim 12, further comprising:
detecting a first command for displaying the second indicator instead of the first indicator through the first message; and
if at least one of the current time and the current location corresponds to the specific use pattern when the indicator corresponding to each of a plurality of the payment cards is displayed, first displaying the second indicator instead of the first indicator.

14. The method of claim 13, further comprising, if at least one of the current time and the current location fails to correspond to the specific use pattern, first displaying the first indicator when the indicator corresponding to each of a plurality of the payment cards is displayed.
